(19) United States
(12) Patent Application Publication
(10) Pub. No.: US 2025/0334407 A1
(43) Pub. Date: Oct. 30, 2025

(54) Fluid-Current and Position Sensor

(71) Applicant: The Penn State Research Foundation, University Park, PA (US)

(72) Inventors: Simone B. Bortolami, State College, PA (US); Jonathan Craig, State College, PA (US); Scott Gift, State College, PA (US); Nicholas Saluzzi, State College, PA (US); David Redington, State College, PA (US); Ronak S. Darji, State College, PA (US)

(21) Appl. No.: 19/044,725

(22) Filed: Feb. 4, 2025

Related U.S. Application Data
(60) Provisional application No. 63/549,810, filed on Feb. 5, 2024.

(51) Int. Cl. G01C 13/00; G01D 5/353

(52) U.S. Cl. CPC G01C 13/002; G01D 5/35316; G01D 5/35361

(57) ABSTRACT

Embodiments can relate to a fluid current and position measurement instrument. The instrument can include an elongate structure (having a first end and a second end) capable of flexible movement and deflection. The instrument can include a sensor system having plural organic sensor instruments (OSIs) configured to: sense drag force, tension, deformation, deflection, and/or rotations experienced by the elongate structure; and generate sensor signals representative of the same. The sensor system can include a communication medium in communication with the plural OSI and configured to transmit the sensor signals to the first end and the second end. The instrument can include a processing module (having a processor and a memory) configured to receive the sensor signals and determine: i) flow rate, flow direction, and fluid density of one or more fluid flow currents of the fluid column, ii) position and/or velocity of the second end relative to the first end.

### CROSS-REFERENCE TO RELATED APPLICATIONS

This patent application is related to and claims the benefit of priority to U.S. provisional patent application No. 63/549,810, filed on Feb. 5, 2024, the entire contents of which is incorporated by reference.

### FIELD OF THE INVENTION

Embodiments can relate to a fluid current sensor in the form of a tether connected between a buoy or a surface or subsurface vehicle, herewith addressed as “surface or subsurface expression,” (SE) and an underwater vehicle (UV or UUV if unmanned) that can sense fluid currents of a water column within which the tether is immersed and aid the estimate or prediction of the vehicle's position relative to the surface or subsurface expression.

Embodiments can also relate to a positioning sensor in the form of a tether connected between a surface or subsurface expression and an underwater vehicle and immersed in the water column that aids the estimate or prediction of the UV's position relative to the surface or subsurface expression by using angular measurements of the tether orientation at its extremities with respect to the expression and the vehicle.

### BACKGROUND OF THE INVENTION

Global Navigation Satellite Systems (GNSS) provide ubiquitous and accurate geodetic positioning. However, GNSS updates are unavailable underwater. With the growing commercial and government interests in Underwater Vehicles (UU), novel underwater navigation solutions are required to meet mission requirements. Currently, most UVs start at the ocean's surface where they acquire their initial position from a GNSS. However, as soon as they start diving, they lose this aiding source. While maneuvering down and through the water column, the UV is transported by ocean currents. Without knowing the absolute speed and direction of the ocean currents, the UV navigation system rapidly accumulates large position uncertainty. Currently, the most common countermeasure is a sonar system to track the seafloor to provide Earth referenced velocity measurements. Depending upon many factors not limited to the depth of the ocean, the type of sonar, the orientation of the UV, and the available power onboard the UV, a ground track might not be available for the majority of the dive. Certainly, this is the case for a small UV diving in a deep ocean. Even with a marine-grade Inertial Navigation System (INS), a UV can suffer large position uncertainties in the order of hundreds of meters to kilometers. For example, one knot ocean current acting upon an UV while descending for two hours can cause a navigation position uncertainty up to two nautical miles. These large errors can lead to an unsuccessful mission.

Known systems can be appreciated from U.S. 2008/0300821.

### SUMMARY OF THE INVENTION

An exemplary embodiment can relate to a fluid current measurement and/or position sensing instrument. The instrument can include an elongate structure capable of flexible movement and deflection due to fluid flow within a fluid column the elongate structure is immersed. The elongate structure can have a first end and a second end. The instrument can include a sensor system. The sensor system includes different sensors including plural Organic Sensor Increments (OSI). The plural OSI can function to sense drag force, tension, deformation, deflection, and/or rotation experienced by the elongate structure at the first end, the second end, and an intermediate point between the first end and the second end. The plural OSI can be operated to generate sensor signals representative of drag force vectors, tension force vectors, deformation, deflection, and/or rotation. The sensor system can include a communication medium in communication with the plural OSI. The communication medium can be configured to transmit the sensor signals to the first end and the second end. The instrument can include a processing module. The processing module can include a processor and a memory. The processing module can be configured to receive the sensor signals and determine flow rate, flow direction, and fluid density of one or more fluid flow currents of the fluid column. The processing module can also be configured to determine position of the second end relative to the first end.

In some embodiments, the elongate structure can be a tether configured to connect to a Surface or Subsurface Expression (SE) at its first end and to an Underwater Vehicle (UV) at its second end. The processing module can be located at the SE or at the UV. The processing module can be configured to determine a position of the UV relative to the SE based at least in part on the flow rate, the flow direction, and the fluid density of the one or more fluid flow currents of the fluid column.

In some embodiments, the sensor system can include one or more load sensor, pressure sensor, force sensor, motion sensor, rotation sensor, flow sensor, Bragg grating, and/or Rayleigh scattering sensor.

In some embodiments, the communication medium can be a flexible electrical conductor or a flexible optical waveguide.

In some embodiments, the flexible electrical conductor can be an electrical conducting metal, metal alloy, or polymer. The flexible optical waveguide can be an optical fiber.

In some embodiments, the elongate structure can be covered with a coating.

In some embodiments, the coating includes a protective material that is a high-strength cladding material or a high-strength braided material. In addition, or in the alternative, the coating can include a buoyant material.

In some embodiments, the SE can include a 3D load cell, an Internal Navigation System (INS), a Global Navigation Satellite System (GNSS), other global positioning sensors, and angular sensors, each of which provide data to the processing module. The UV can include a 3D load cell, a depth sensor, a Doppler velocity sensor, and an INS, each of which provide data to the processing module.

In some embodiments, the SE can a deployer that controllably releases or retracts the elongate structure and can determine a length of the elongate structure as measured from the deployer to the second end.

In some embodiments, the plural OSIs can be configured to sense drag force, tension, deformation, deflection, and/or rotation experienced by the elongate structure at plural intermediate points between the first end and the second end.

In some embodiments, the processing module can be configured to compute a profile of the elongate structure, the profile comprising plural overall shapes of the elongate structure at plural times, t, over a period of time, T.

In some embodiments, the processing module can be configured to model one or more fluid flow currents based on inflection points in the profile.

In some embodiments, modelling one or more fluid flow currents can involve estimating fluid flow current speed based on recursive analysis.

In some embodiments, the sensor system can be configured to sense drag force, tension, deformation, deflection, and/or rotation experienced by the elongate structure at plural intermediate points between the first end and the second end. The processing module can be configured to compute a profile of the elongate structure, the profile comprising plural overall shapes of the elongate structure at plural times, t, over a period of time, T. The processing module can be configured to model one or more fluid flow currents based on inflection points in the profile. The processing module can be configured to update and/or predict the position of the UV relative to the SE.

In some embodiments, modelling one or more fluid flow currents can involve estimating fluid flow current speed based on recursive analysis.

An exemplary embodiment can relate to a fluid current measurement and/or position sensing instrument. The instrument can include an elongate structure capable of flexible movement and deflection due to fluid flow within a fluid column the elongate structure is immersed. The elongate structure can have a first end connectable to a SE and a second end connectable to an UV. The instrument can include a sensor system. The sensor system can include plural OSI sensors. The plural sensor can be configured to: sense drag force, tension, deformation, deflection, and/or rotation experienced by the elongate structure at the first end and the second end; sense an angle between a longitudinal axis of the elongate structure at its first end and a reference frame of the SE; sense an angle between a longitudinal axis of the elongate structure at its second end and a reference frame of the UV; and generate sensor signals representative of drag force vectors, tension force vectors, deformation, deflection, rotation, and/or angles. The sensor system can include a communication medium in communication with the plural OSIs and configured to transmit the sensor signals to the first end and the second end. The instrument can include a processing module comprising a processor and a memory. The processing module can be configured to receive the sensor signals. The processing module can be configured to: a) determine flow rate, flow direction, and fluid density of one or more fluid flow currents of the fluid column; b) determine a position of the second end relative to the first end using a mathematical model of an overall shape of the elongate structure; and/or c) determine a position of the second end relative to the first end using shape data from a curvature sensor of the elongate structure.

In some embodiments, the processing module can be configured to infer a relative position of the UV with respect to the SE.

In some embodiments, the curvature sensor can include an optical fiber with Bragg grating or a Rayleigh scattering sensor.

In some embodiments, the processing module can be configured to determine inflection points in the overall shape of the elongate structure using flow rate and/or direction data, the mathematical model, and/or shape data from the curvature sensor.

Further features, aspects, objects, advantages, and possible applications of the present invention will become apparent from a study of the exemplary embodiments and examples described below, in combination with the Figures, and the appended claims.

### BRIEF DESCRIPTION OF THE DRAWINGS

The above and other objects, aspects, features, advantages and possible applications of the present innovation will be more apparent from the following more particular description thereof, presented in conjunction with the following drawings. Like reference numbers used in the drawings may identify like components.

FIG. 1 shows an exemplary embodiment of the fluid current and position sensor.

FIG. 2 shows covariance simulation results of position accuracy with and without embodiments of the fluid-current and position sensor.

FIG. 3 shows an embodiment of the fluid-current and position sensor superimposed on a depiction of a possible application represented in a geodetic coordinate plot.

FIG. 4 illustrates modeling quantities of an embodiment of the tether.

FIG. 5 shows how the model of the tether relates to the fluid flow and its forces.

FIG. 6 illustrates quantities used by the fluid-current and position sensor to determine speed and direction of a fluid current and the position of a UV with respect to a SE and the world.

FIG. 7 illustrates how an embodiment of the fluid current sensor can determine a UV's relative position.

FIG. 8 shows how an embodiment of the fluid-current and position sensor manages different flows/currents within a fluid column.

FIG. 9 shows an experimental set up in a wind tunnel to test an exemplary implementation of the fluid-current and position sensor.

FIG. 10 shows results of wind tunnel tests using one exemplary mathematical implementation of TODD.

FIGS. 11A and 11B illustrate the effectiveness of an embodiment of the fluid-current and position sensor to sense current velocity position of one end of the elongated structure with respect to the other.

FIGS. 12A and 12B show covariance analyses with velocity and relative position measurements for a possible UV mission.

FIG. 13 shows typical stratified current zones in an ocean environment as they may relate to a UV dive.

FIG. 14 is a depiction of one tether section subjected to one current with one direction; also a modeling element of the elongated structure.

FIGS. 15A and 15B show different mission capabilities for embodiments of TODD.

FIG. 16 shows preliminary simulation results.

FIGS. 17A, 17B, 17C, and, 17D show modeling results of fluid-current and position sensor during examples of UV dives inclusive of shapes, forces, yielded position accuracies.

FIG. 18 shows preliminary simulation results with an iXblue MARINS M7 INS.

FIG. 19 shows preliminary simulation results with a Honeywell HG9900 INS.

FIG. 20 shows preliminary simulation results with a Phins C3 INS.

FIG. 21 shows how embodiments of the disclosed system can address presence of ocean currents of different directions at depth using a composition of the tether's sections in different planes that share common boundary conditions.

FIG. 22 shows exemplary market-place acoustic-bases system solutions.

### DETAILED DESCRIPTION OF THE INVENTION

The following description is of exemplary embodiments that are presently contemplated for carrying out the present invention. This description is not to be taken in a limiting sense, but is made merely for the purpose of describing the general principles and features of the present invention. The scope of the present invention is not limited by this description.

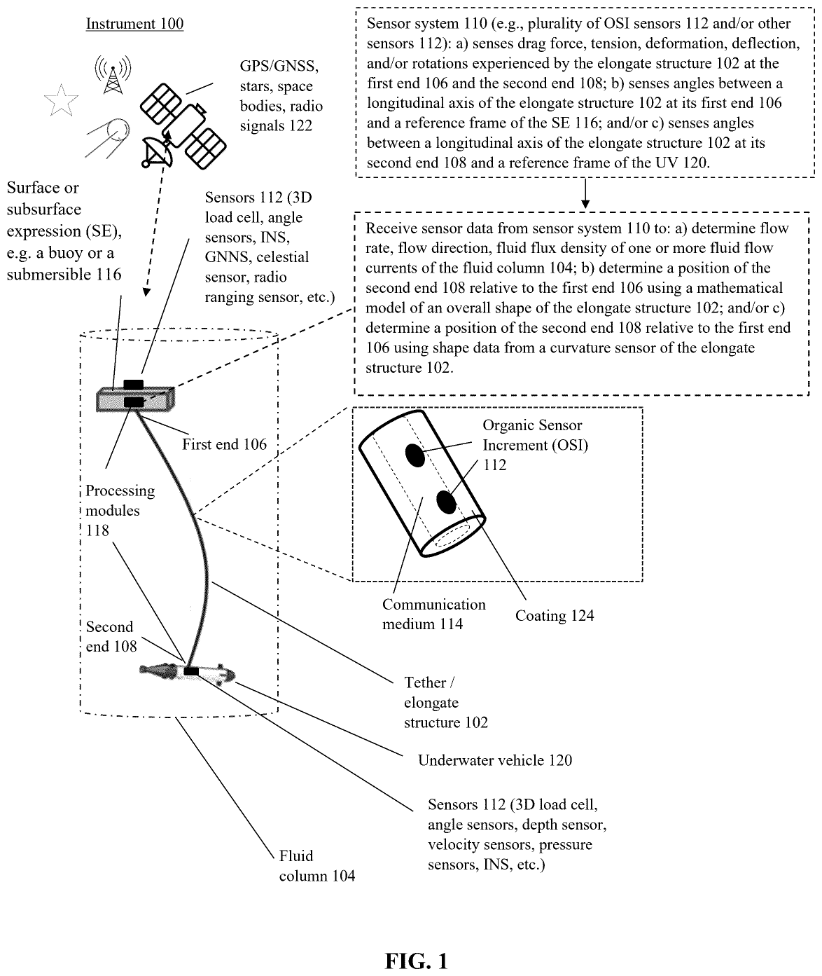

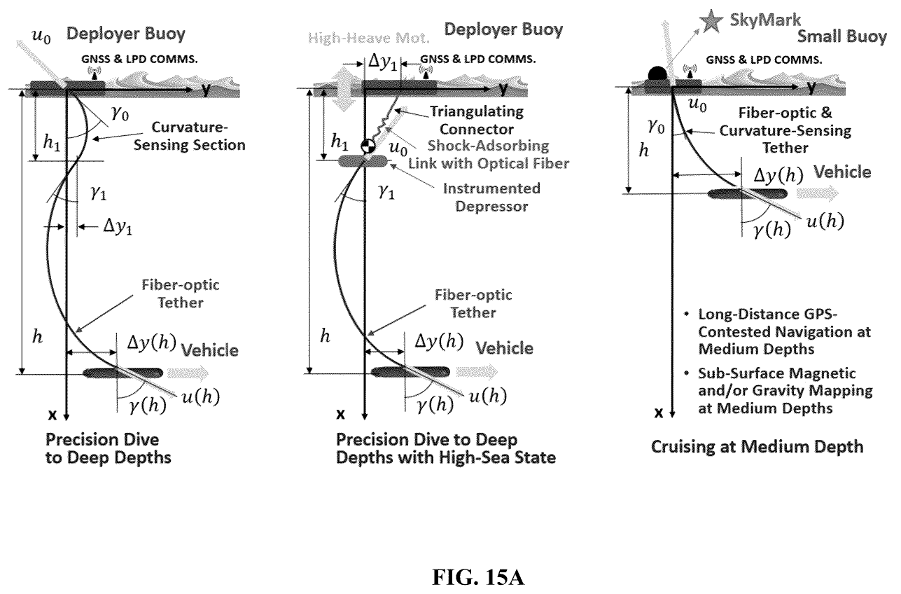

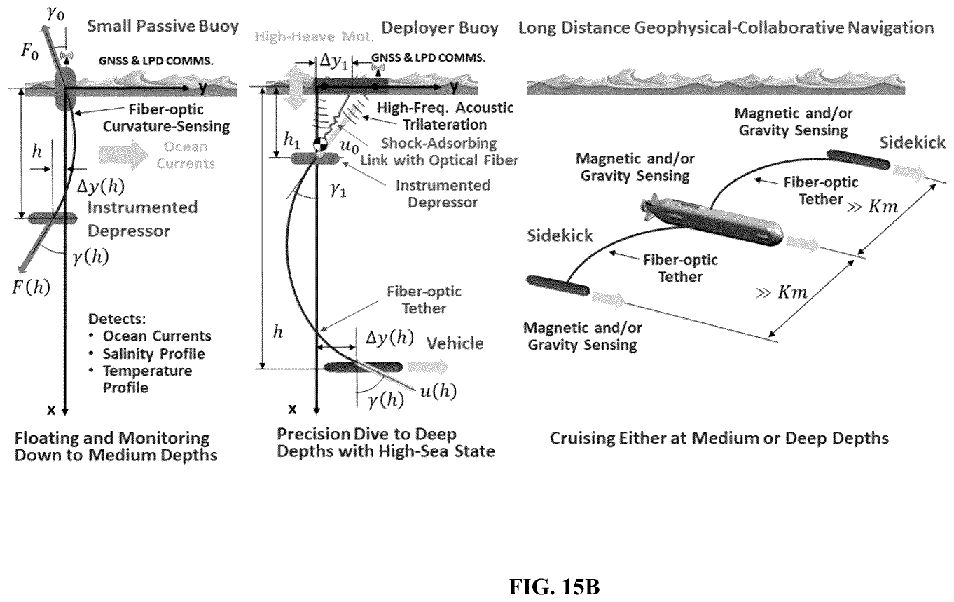

Referring to FIG. 1, embodiments can relate to a fluid-current measurement and/or position sensing instrument 100. The fluid can be gas or liquid. It is contemplated for the fluid to be ocean water. The instrument 100 can include an elongate structure 102. The elongate structure 102 can be capable of flexible movement and deflection due to fluid flow within a fluid column 104 the elongate structure 102 is immersed. For instance, the elongate structure 102 can have a first end 106 and a second end 108 with a longitudinal axis extending from the first end 106 to the second end 108. In use, it is contemplated for the elongate structure 102 to be placed in an environment so as to be surrounded by the fluid (e.g., ocean water) such that the longitudinal axis will generally be in vertically oriented—e.g., the first end 106 will be at or near the ocean surface or attached to a SE 116 (which may be at or below the ocean surface) and the second end 108 will be submerged at a depth beneath the ocean surface or beneath the SE 116. However, it is understood that the elongated structure 102 can also be operation horizontally or off-vertical as depicted in FIG. 15B. The fluid surrounding the elongate structure 102 when placed in such environment defines a fluid column 104. Depending on the depth of the second end 108 beneath the ocean surface, there may be one or more fluid currents (defined by a magnitude and direction of fluid flow) acting upon the elongate structure 102. Each fluid current can impose a force on the elongate structure 102 to cause it to move, flex, bend, deflect, rotate, etc.

The instrument 100 can include a sensor system 110. The sensor system 110 can include one or more Organic Sensor Increments (OSIs) 112. It is contemplated for the sensor system 110 to include plural OSI 112. One or more OSI 112 can be configured to sense forces acting upon and/or experienced by the elongate structure 102 and/or deflections. This can include forces and angular deflections caused by the fluid current(s) within the fluid column 104. While other quantities can be sensed, it is contemplated for the OSI(s) 112 to at least sense drag force(s), tension(s), deformation(s), deflection(s), and/or rotation(s) experienced by the elongate structure 102. It is further contemplated for the OSI(s) to sense drag force(s), tension(s), position(s), and angular deflection(s) at least at the first end 106, the second end 108, and one or more intermediate points between the first end 106 and the second end 108. Exemplary OSI(s) 112 functions can include one or more of load sensing, pressure sensing, force sensing, motion and rotation sensing, flow sensing, Bragg grating sensing, and Rayleigh scattering sensing, etc. as organic and homogenous to the material of the elongate structure and performed by it without the use of embedded exogenous additional sensors. For instance, it is known with conventional system to use exogenous sensors (e.g., gyros, magnetometers, force sensors, etc.) embedded in sections of an elongated structure (e.g., conventional systems use flexible tether segments separated by sensors—see, e.g. US 2008/0300821) which use measurements therefrom and a model of arches of the elongated structure to yield a position of one end with respect to the other. Contrary to this, embodiments of the instrument 100 do not utilize embed exogenous sensor between sections of the elongated structure 102, but uses the elongated structure 102 continuum itself to sense stress and strain—it utilizes a plurality of Organic Sensor Increments (OSI). The conventional system of US 2008/0300821 performs all of the sensing in the elongated structure because of its embedded exogenous sensors. Embodiments of the instrument 100, however, uses measurements from the UV 120 and the SE 116 because it does not use embedded sensors different from the elongated structure 102 itself. This structural difference is significant because practical operation of the conventional system of US 2008/0300821 is limited to a few hundreds of meters since its thick cross section is unpractical in high-drag applications, whereas practical operation of embodiments of the instrument 100 can extend to kilometers, e.g., can be used for operations extending to the seafloor.

The OSI 112 can be configured to generate sensor signals representative of the measured force(s). For instance, the OSI 112 can generate sensor signals of the drag force vectors, tension force vectors, deformations, deflections, and/or rotations sensed or measured at first end 106 and the second end 108. In some embodiments, the OSI 112 can generate sensor signals of the drag force vectors, tension force vectors, deformations, deflections, and/or rotations sensed or measured at one or more intermediate points between the first end 106 and the second end 108. This can be in addition to the sensor signals sensed or measured at first end 106, the second end 108.

The sensor system 110 can include one or more communication media 114. Any of the communication medium 114 can be in communication with the sensor(s) 112 and be configured to transmit the sensor signals to the first end 106 and/or the second end 108. For instance, the communication medium 114 can be attached to, part of, embedded with, etc. the elongate structure 102 and extend from the first end 106 to the second end 108. FIG. 1 shows an exemplary embodiment in which the communication medium 114 runs coaxially within a core of the elongate structure 102. It is understood that this is only an exemplary illustration—e.g., the communication medium 114 can run along an outer surface of the elongate structure 102, etc. The communication medium 114 can be a flexible electrical conductor (e.g., electrical conducting metal, metal alloy, polymer, etc.), a flexible optical waveguide (e.g., an optical fiber), a flexible coaxial cable, etc. The communication medium 114 can have lead lines, waveguides, electrical/optical connectors/couplers, switches/circuity, processing blocks, analog to digital converts (ADC), digital to analog converts (DAC), transceivers, antennas, etc. to facilitate pre-processing and transmission of sensor signals to other components (e.g., a processing module 118, processing or sensor components of a SE 116, processing or sensor components of an UV 120, etc.).

While exemplary embodiments may describe and illustrate use of the instrument 100 with an unmanned underwater vehicle (UVV) 120, it is understood that the underwater vehicle (UV) 120 can be manned, unmanned, etc. In addition, while exemplary embodiments may describe and illustrate use of the instrument 100 with one SE 116 located at the surface of the ocean, it is understood that any number of SEs 116 can be used and one or more of them may be located at the surface of the ocean, at a subsurface location within the ocean, etc. It is also understood that the SE 116 as used herein is a device or vessel in which its position (e.g., longitudinal and latitudinal coordinates) and depth within the ocean water can be determined via means other than the instrument 100. For instance, it is contemplated for the SE 116 to have a navigation system that can be used to determine its position and depth with accuracy. The instrument 100 is then used to determine the vehicle's 120 position relative to the SE 116. Thus, the SE 116 can be a device that floats on the surface of the ocean, a device that has a buoyancy to allow it to hold a depth within the ocean water, a surface ocean vessel (e.g., a buoy, a ship), a subsurface ocean vessel (e.g., a submarine, a remotely operated vehicle), etc.

As noted herein, embodiments of the instrument 100 utilize OSIs 112 and does not need exogenous sensors. However, it is possible for embodiments of the instrument 100 to include one or more of exogenous sensors attached to, part of, embedded with the elongate structure 102, the communication medium 114, or a combination of both. Lead lines, waveguides, electrical/optical connectors/couplers, switches/circuity, etc. can be used to facilitate communication of the exogenous sensor with the communication medium 114.

In some embodiments, the communication medium 114 itself can be an OSI 112. For instance, the communication medium 114 can be an optical fiber with one or more Bragg gratings, a Rayleigh scattering sensors, etc. within the optical fiber. A light source (e.g., laser, etc.) can generate and cause light to propagate through the optical fiber and be received by optical receivers. Any bends or stress in/on the optical fiber (e.g., due to fluid currents) can be detected via optical shifts at the Bragg gratings, scattering at the Rayleigh scattering sensors, etc.

The instrument 100 can include a processing module 118. Any of the components of the instrument 100 (e.g., the sensor system 110, the communication medium 114, processing or sensor components of the SE 116, processing or sensor components of the UV 120, etc.) can include a processor and a memory to facilitate signal processing, data manipulation, data storage, execution of algorithms, etc. The processing module 118, in particular, includes a processor and a memory with instructions stored thereon that when executed by the processor of the processing module 118 will cause that processor to execute one or more of the functions described herein. For instance, the processing module 118 can be configured to determine fluid flow characteristics of fluid currents based on the sensor signals, and further determine the UV's 120 position and velocity relative to the SE's 116 position based on the same. These determinations are made by executing one or more algorithms stored in memory. The algorithm(s) are based on the mathematical approach disclosed herein of which an exemplary implementation is given herein—e.g., the processing module 118 can be configured to receive the sensor signals and process the sensor signals to determine (via execution of algorithms(s)) flow rate and direction, fluid density, etc. of one or more fluid flow current quantities of the fluid column 104. These algorithm(s) can be based on the equations discuss later. Additional processing, also based on the equations discussed later, can be done to determine UV's 120 relative position. The processing module 116 can include lead lines, waveguides, electrical/optical connectors/couplers, switches/circuity, processing blocks, analog to digital converts (ADC), digital to analog converts (DAC), filters, processing blocks, transceivers, antennas, etc. to facilitate receiving/transmitting, processing, storing, etc. signals and data.

Any of the processors can include or be operatively associated with a memory. The memory can store instructions thereon which can be executed by the processor to perform any of the functions disclosed herein. The instructions can be in the form of computer logic, algorithms, models, etc. and stored as a computer program, a data structure, etc. While exemplary embodiments may describe and/or illustrate one processor and one memory, it is understood that the instrument 100 can include any number of processors and memories.

The processor can be part of or in communication with a machine (logic, one or more components, circuits (e.g., modules), or mechanisms). The processor can be hardware (e.g., processor, integrated circuit, central processing unit, microprocessor, core processor, computer device, etc.), firmware, software, etc. configured to perform operations by execution of instructions embodied in algorithms, data processing program logic, artificial intelligence programming, automated reasoning programming, etc. Use of processors herein can include any one or combination of a Graphics Processing Unit (GPU), a Field Programmable Gate Array (FPGA), a Central Processing Unit (CPU), etc. The processor can include one or more operating modules. An operating module can be a software or firmware operating module configured to implement any of the method steps disclosed herein. The operating module can be embodied as software and stored in memory, the memory being operatively associated with the processor. An operating module can be embodied as a web application, a desktop application, a console application, etc.

The processor can include or be associated with a computer or machine readable medium. The computer or machine readable medium can include memory. The computer or machine readable medium can be configured to store one or more instructions thereon. The instructions can be in the form of algorithms, program logic, a model, etc. that cause the processor to perform any of the functions described herein.

Any of the memory discussed herein can be computer readable memory configured to store data. The memory can include a volatile or non-volatile, transitory or non-transitory memory, and be embodied as an in-memory, an active memory, a cloud memory, etc. Embodiments of the memory can include an operating module and other circuitry to allow for the transfer of data to and from the memory, which can include to and from other components of a communication system. This transfer can be via hardwire or wireless transmission. The communication system can include transceivers, which can be used in combination with switches, receivers, transmitters, routers, gateways, wave-guides, etc. to facilitate communications via a communication approach or protocol for controlled and coordinated signal transmission and processing to any other component or combination of components of the communication system. The transmission can be via a communication link. The communication link can be electronic-based, optical-based, opto-electronic-based, quantum-based, etc.

The processor can be in communication with other processors of other devices (e.g., a computer device, a desktop computer, a laptop computer, a computer system, etc.). Any of those other devices can include any of the exemplary processors disclosed herein. Any of the processors can have transceivers or other communication devices/circuitry to facilitate transmission and reception of wireless signals. Any of the processors can include an Application Programming Interface (API) as a software intermediary that allows two applications to talk to each other. Use of an API can allow software of the processor of the system to communicate with software of the processor of the other device(s), if the processor of the system is not the same processor of the device.

Any data transmission between a processor and a memory, between a processor and a database, between a processor and processors of other devices, between a processor of one operating module and a processor of another operating module, etc. can be via a pull operation (e.g., the processor can pull the data) or a push operation (e.g., the data can be pushed to the processor). The processor can receive and process the data in steaming format, store it in memory before being processed, etc.

As noted herein, the processor can be configured to be a component of, used in combination with, or in communication with another device/system—e.g., this can include the processor being part of the device/system, the device/system being part of the processor, the processor in communication with the device/system, etc. “Being part of” can include being on a same substrate or integrated circuit. For instance, the processor can be a component of, used in combination with, or in communication with a predictive modeling system, a decision support system, an automated control system, etc. The processor can use the techniques disclosed herein to assist with or augment the performance of these devices/systems.

While exemplary embodiments may describe and illustrate a particular number of instruments 100, elongate structures 102, sensor systems 110, OSI 112, communication media 114, processing modules 116, etc. for an application or implementation, it is understood that any number or combination thereof can be used to satisfy certain design criteria.

As noted herein, a contemplated exemplary use of the instrument 100 is use within an ocean environment, and in particular use with a vehicle 120 (e.g., an underwater vehicle, an unmanned underwater vehicle, etc.). For instance, the instrument 100 can be used to accurately determine the UV's 120 position when conducting oceanic operations beneath the ocean's surface. In this regard, the elongate structure 102 can be configured as a tether that will connect to a SE 116 at its first end 106 and to an UV 120 at its second end 108. It is contemplated for the processing module 118 to be located at the SE 116, but it can be located at the UV 120, or even located at a different place (e.g., be part of a computer device/system on a vessel, be part of a computer device/system located on land, etc.). The processing module 118 can be configured to determine (e.g., calculate, estimate, refine, update, predict, etc.) a position of the UV 120 relative to the SE 116. This determination can be based at least in part on the flow rate and direction, the fluid density, etc. of the one or more fluid flow currents of the fluid column 104. For instance, the flow rate and direction, the fluid density, etc. of the one or more fluid flow currents of the fluid column 104 can provide information to evaluate if, how, and to which degree any of the fluid currents is effecting or has effected the navigation of the UV 120—e.g., if, how, and to which degree any of the fluid currents acts/acted as head currents, tail currents, cross currents, etc. This evaluation over a period of time and with other information such as depth of the UV 120 over time can allow the processing module 118 to calculate, estimate, refine, update, predict, etc. the UV's 120 position relative to the SE 116. Again, the equations for determining the UV's 120 position relative to the SE 116 are discussed later. Position relative to the SE 116 is used because the SE 116, being above the ocean surface or having means to communicate with systems above the ocean surface, can have a navigation system that is in communication with a Global Positioning System (GPS) satellite and/or other GNSS or other radio-frequency or stellar positioning systems 122, and therefore its position can be accurately determined via such means.

As the ocean environment can be harsh, the elongate structure 102 and/or the sensor system 110 can be covered with a coating 124. The coating 124 can be a protective material such as a high-strength cladding material, a high-strength braided material, etc. The protective material can be metal, plastic, polymer, carbon fiber, composite material, etc.

In addition, the elongate structure 102 and/or the sensor system 110 can be coated 124 with a material that is buoyant so as to provide some buoyancy to the elongate structure 102 when deployed in the ocean. In some embodiments, the coating 124 can be both a protective material and a buoyant material.

It is contemplated for the SE 116 and for the UV 120 to include other sensors 112 (e.g., angular sensors, position sensors, force sensors, navigation systems, communication systems, sensors to measure angles between the curvilinear axis elongate structure 102 and the bodies of the SE and UV, etc.) that can also generate signals/data that can be transmitted to the processing module 118. The processing module 118 can use these signals/data to augment the sensor signals, perform sensor fusion techniques with the sensor signals, confirm or validate it determinations, etc. For instance, the SE 116 can include a 3D load cell sensor (to measure tension at the elongate structure's 102 first end 106), an INS, a GNSS, etc. The GNSS may be in communication with the GPS satellite 122. The UV 120 can include a 3D load cell sensor, angular sensors, velocity sensors, e.g., Doppler velocity sensor EMLog, Pitot, Differential Pressure sensor, INS, etc. (to measure tension, angles, velocity etc. at the elongate structure's 102 second end 108). The SE 116 and the UV 120 can each include a processor and memory to facilitate signal/data processing, communication with these systems/sensors, communication with the instrument 100, etc.

As noted herein, the elongate structure 102 can be configured as a tether between a UV 120 and a SE 116. As the UV 120 ascends or descends in the water, the tether's length would have to be adjusted. This can be achieved via a deployer systems, e.g., winch with a rotary sensor or a passive spool with a pay-out length measuring device or other. It is also contemplated for the length of the tether (as measured from the deployer to the second end 108) to be recorded and transmitted to the processing module 118 as another signal or data point to use for its calculations. This can be achieved via a sensor, e.g., an encoder for a winch or other pay-out length sensors for other solutions. The encoder sensor can include a processor and memory to facilitate signal/data processing and communication with the instrument 100. In an exemplary embodiment, the SE 116 includes the winch and encoder sensor that controllable releases or retracts the elongate structure 102 and determines a length of the elongate structure 102 as measured from the winch to the second end 108.

As noted herein, the instrument 100 can determine and/or track one or more fluid currents that has or is acing upon the elongate structure 102, which can facilitate determining the position of the UV 120 relative to the SE 116. Each fluid current that has or is acting upon the elongate structure 102 had or is imposing a force on the elongate structure 102 which had caused or is causing it to move, flex, bend, deflect, etc. Thus, at any given point in time, the elongate structure 102 will have an overall shape, depending on the number of, the magnitude of, and direction of the fluid currents acting upon it. If measured and recorded over a period of time, a profile (e.g., shape profile) of the elongate structure 102 can be generated that is a record of the current and past overall shapes of the elongate structure 102. Thus, the processing module 118 can be configured to compute a profile of the elongate structure 102, the profile comprising plural overall shapes of the elongate structure 102 at plural times, t, over a period of time, T. The interval between times, t, can be predetermined, set by an algorithm that takes into account factors associated with the environment and application the instrument 100 is used, set by a user controlling the instrument 100, can be a set interval, can be an adjustable interval, etc. The period of time T can be predetermined, set by an algorithm that takes into account factors associated with the environment and application the instrument 100 is used, set by a user controlling the instrument 100, can be a set period, can be an adjustable period, etc.

With the profile of the elongate structure 102 determined, the processing module can then model one or more fluid flow currents based on inflection points in the profile. The model can be a representation identifying and tracking fluid currents within the fluid column 104 over time. The modelling can involve estimating fluid flow current speed of one or more of the fluid currents. This can be done via recursive analysis, for example. These analyses, along with signals/data from the depth sensor, encoder, etc. can be used to determine if, how, and to which degree any of the fluid currents affected the position or movement of the UV 120—e.g., it can be determined if, how, and to which degree any of the fluid currents are acting or acted as a head current, a tail current, and/or a cross current on the UV 120. In addition, or in the alternative, the results of the processing module 118 can be used to update and/or predict the determined position of the UV 120 relative to the SE 116. For instance, the processing module 118 can be configured to determine the relative position of the UV 120 continuously, at set times, on-demand by a user, as set by an algorithm that takes into account factors associated with the environment and application the instrument 100 is used, etc., which can then update the previous determined relative position. As another example, the processing module 118 can include predictive analytics models, artificial intelligence models, etc. to predict what the UV's 120 relative position is, should be, was in the past, will be in the future, etc.

As can be appreciated, the embodiments of the fluid current measurement and/or position sensing instrument 100 can be configured to operate in one or more modes. These modes can include: a) determining fluid current flow/speed and direction; b) determining position of the second end 108 (and infer therefrom a position of the UV 120) relative to the first end 106 based on a mathematical model of an overall shape of the elongate structure 102; and/or c) determining position of the second end 108 (and infer therefrom a position of the UV 120) relative to the first end 106 based on elongate structure 102 shape data obtained from a curvature sensor using 112.

For instance, the instrument 100 can include an elongate structure 102 capable of flexible movement and deflection due to fluid flow within a fluid column the elongate structure 102 is immersed. The elongate structure 102 can have a first end 106 connectable to a SE 116. The elongate structure 102 can have a second end 108 connectable to UV 120.

The instrument 100 can include a sensor system 110. The sensor system 110 includes plural sensors 112. The plural sensors 112 can be one or more sensors 112 attached to or associated with the SE 116, one or more sensors 112 attached to or associated with the UV 120, and/or one or more OSI 112 associated with the elongate structure 102. Exemplary sensors were discussed above. The sensor system 110 can be configured to measure drag force experienced by the elongate structure 102 at the first end 106 and the second end 108. In addition, or in the alternative, the sensor system 110 can be configured to measure an angle between a longitudinal axis of the elongate structure 102 at its first end 106 and a reference frame of the SE 116 and/or measure an angle between a longitudinal axis of the elongate structure 102 at its second end 108 and a reference frame of the UV 120. For instance, sensors 112 located at the SE 116 and UV 120 can measure the tilt angle the elongate structure 102 makes with respect to the SE 116 and with respect to the UV 120, which can then be used to determine drag force(s) experiences by the elongate structure 102. Formula to determine this are discussed below.

The sensor system 110 can include a communication medium 114 in communication with the plural sensors 112 and/or OSIs 112 and configured to transmit the sensor signals (e.g., signals representative of drag force vectors and/or angles) to the first end 106 and the second end 108. Exemplary communication media 114 were discussed above.

The instrument 100 can include a processing module 118 configured to receive senor signals. The processing module 118 can use the sensor signals to operate in one or more operational modes. In a first operational mode, the processing module 118 can determine flow rate, flow direction,, and/or fluid flux density of one or more fluid flow currents of the fluid column 104. This can be achieved by using any of the formulas disclosed herein. In a second operational mode, the processing module 118 can determine a position of the second end 108 relative to the first end 106 using a mathematical model (discussed below) of an overall shape of the elongate structure 102. Because the second end 108 is attached to the UV 120, determining the relative position of the second end 108 will also determine the relative position of the UV 120, or at least allow the processing module 118 to infer the relative position of the UV 120. In a third operational mode, the processing module 118 can determine a position of the second end 108 (and the UV 120) relative to the first end 106 using shape data from a curvature sensor of the elongate structure 102. The curvature sensor can be an optical-fiber sensing technology using Bragg grating or Rayleigh scattering, for example.

The processing module 118 can operate in any one or combination of these modes (e.g., it can operate in a single mode, operate in a mode selected by a user, operate in a mode determined to be the best mode based on conditions, operate in two or more modes simultaneously, use one mode to augment another mode, use one mode to validate another mode, etc.). Again, because the second end 108 is attached to the UV, the processing module 118 can infer a relative position of the UV 120 with respect to the SE 116 based on the relative position of the second end 108. Inferences can be made via sensor fusion techniques, predictive analytics, etc.

As noted herein, the overall shape of the elongate structure 102 can be determined by the processing module 118. Determining the overall shape can involve determining if, when, and to which degree an inflection occurs in the elongate structure 102. This can be determined by curvature or shape measurements from the OSI 112 and/or other sensors 112 and/or by the processing module 118 determining inflection points in the overall shape of the elongate structure 102 using flow rate data, the mathematical model, and/or shape data from the curvature sensor. Examples presented herein discussed details of how this can be achieved.

### EXAMPLES

The following disclosure provides results of exemplary systems and implementations of the embodiments discussed herein. Exemplary implementations in this example section refer to embodiments of the instrument 100 as a Tethered Ocean Deep Dive (TODD) system. The example section sets forth exemplary equations and models that can be used with TODD. It is contemplated to use different equations depending on the best fit of specific—expected or detected—ocean current relative velocity profiles. For instance, EXAMPLE I uses equations for parabola model, but in other cases of ocean current and UV motion, it may be beneficial to use other equations, e.g., a cubic model. EXAMPLE 2 uses equations for cubic model. It is further understood that other models can be used and that use of parabolic and cubic models are non-limiting examples.

### Example 1

The TODD system uses a thin passive tether, similar to a fishing line, to sense the ocean currents during the UV descent. A UV with the TODD system can maintain good navigation performance throughout its dive until a sonar system can obtain a bottom lock, if so desired by a specific mission, but not mandatorily. While descending, the UV unspools the tether from a SE at a surface that is instrumented with a GNSS receiver providing position and velocity measurements. At its extremities, the tether exercises tensions whose magnitudes and directions are also functions of the velocities and directions of the water currents above. TODD uses these tensions and angles of the tether at its ends to sense the ocean currents, and their effects, experienced while descending. In turn, these ocean current velocities and directions, angular measurements, force measurements, depth measurements are used individually or in association to aid the INS onboard the UV.

More specifically, during the descent the tether orients with the water current(s) providing observability of the absolute direction(s) of the current(s), which are carrying the UV adrift. Tether dynamics is well understood and the tether's orientation at the attachment points are measured by the UV during the running time of the descent together with the length of the tether being deployed. These measurements provide observability on the relative displacement of the UV with respect to the SE. In addition, the forces exercised at the extremities of the tether—and their directions—are function of the drag force of the tether in the water, which in turn are functions of the speed(s) of the current(s), thus providing observability on the speed(s) of the drifting current(s). The observations of the relative UV position and of the ocean current(s) together or independently are used to aid the UV INS to increase its navigation accuracy during descent especially for deep dives. When many water currents are present, currents are progressively identified as the UV descends through them.

Analyses show that commercially available force and/or angular sensors installed on the SE and the UV provide all measurements necessary to TODD. The technology exploits the well understood dynamics of a tether in a force vector field that facilitates inferring the shape of the tether given the knowledge of the force vector field, or vice versa—in special cases—the force vector field given the shape of the tether. The latter is determined by its boundary conditions, e.g., the magnitude and direction of the tensions mentioned herein and/or the relative orientations of the curvilinear axis of the elongated structure 102 with respect to the body of the SE and UV respectively.

Results of the navigation covariance analyses were corroborated by comparable UV analyses from real mission data. Covariance simulations of different types of mission and Concept of Operation (CONOPS) were performed in accordance with common practices of the UV community. Generally, a UV can dive with different down angles and velocities, either on a straight path or on a spiral. Different descent trajectories stimulate different type of INS error components. For example, a vertical spiral being advantageous for certain aspects, puts to task the good stability of the gyro's scale factor of the INS. A CONOPS that answers the needs of a mission and the capability of the UV in use also drives the overall duration of the dive, which in turn drives the platform position uncertainty.

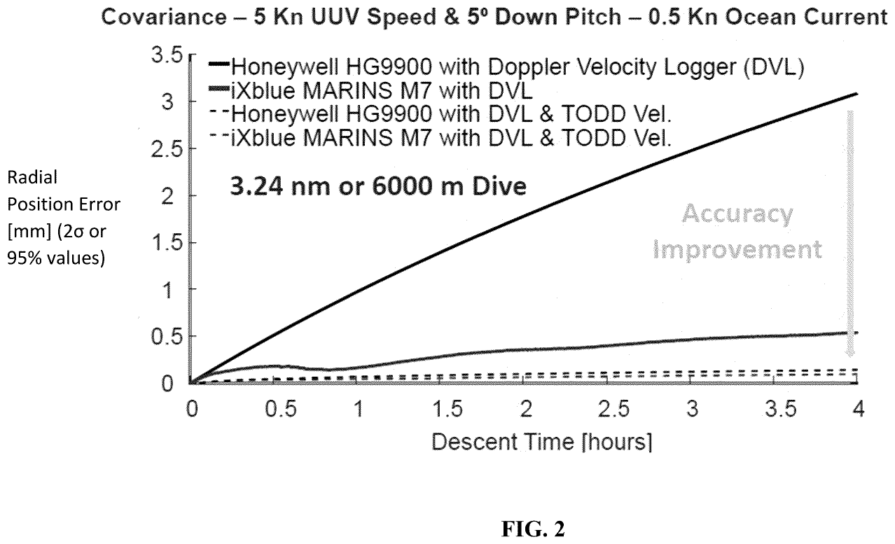

Throughout all different use-cases (see FIG. 2 for example), covariance simulations show systematic and substantial benefits of TODD in improving the positioning accuracy of the UV. For an example, results show that even with an HG9900 Inertial Measurement Unit, the UV position error at the seafloor, after a four-hour, three-thousand meters descent, is a small fraction of the position error without TODD. Moreover, the performance of a HG9900 using TODD is comparable to the performance of a much-higher marine-grade IMU aided with TODD. Adding the additional position measurement from TODD improves the navigation performance further.

TODD allows for placing small to medium UVs at very large depths with accuracies that were not possible before. TODD allows for the use of smaller and cheaper UVs, because the onboard sensor suites can be lower power, lower cost, and lower performance than currently used for a given type of mission, while providing a comparable overall navigation performance. TODD allows for lower classifications of UVs to newly perform missions that were traditionally prerogative of higher classification UVs.

As can be appreciated, the dive of an UV starts at the surface, or in the air, where a GNSS is available and its INS can align, calibrate, and prepare for the dive. As soon as the UV dives, the GNSS is lost and the ocean currents transport the UV away. Not knowing the speeds and directions of the ocean currents, the INS of the UV rapidly accumulates large position and velocity uncertainties. A countermeasure is to track the seafloor with a sonar to provide Earth referenced velocity to the UV INS. For deep dives and/or with low-cost UVs, this is not possible. Very expensive and large Size Weight and Power (SWaP) INS's can be of assistance, but they do not resolve the problem. The TODD system can provide a position update to the UV INS by sensing the relative position of the UV with respect to the SE, whose position and velocity are known, and observe ocean current velocities and directions to resolve this problem.

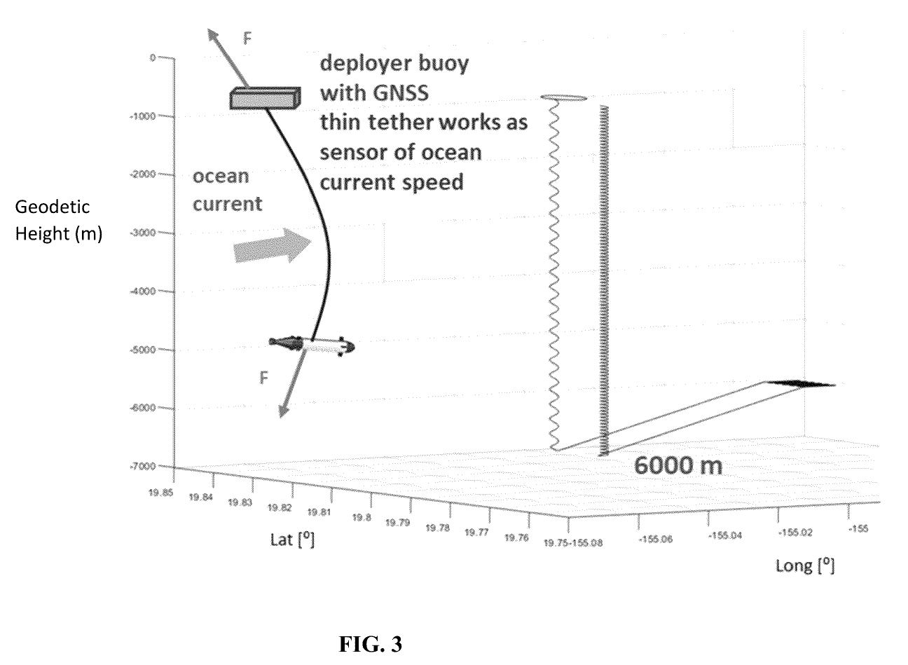

Referring to FIG. 3, UVs commonly use umbilical cables as thin as optical fibers to connect with the surface for steering commands and other telemetry data. A long and light tether of braided high-strength material hosting a communication medium can be used in a similar fashion. As a fishing line in the water, the umbilical tether will orient with the current, thus showing the geodetic heading of the ocean current. The drag force exercised on the tether is also proportional to the relative velocity of the water current with respect to the tether. The sum of the horizontal components of the forces sensed at the UV's and SE's ends well-approximates the drag force on the tether when the whole system does not (or slowly) accelerate(s). The shape of the tether assumed in the water also provides observability of the relative position of one tether end with respect to the other, thus the relative position on the UV with respect to the SE's GNSS receiver. Sensing the direction and magnitude of the tether tension at both ends provides observability of ocean current velocity and direction with respect to a geodetic frame. Both INS on the deployer of the SE on the UV can hold their tilts and headings with respect to a geodetic frame with sufficient accuracy. Both the SE and the UV have force sensors to measure the tether tension in magnitude and direction with respect to their body frames. The SE with the GNSS receiver also measures the length of the tether deployed over time. The UV measures its depth (depth sensor) and its relative velocity with respect to the water column, e.g., with a Doppler Velocity Logger (DVL) or a differential pressure sensor, Pitot, EMlog or other. In real time, the SE communicates to the UV its position and velocity, the tether's tension and direction with respect to the geodetic frame, and the length of the tether deployed. A filter on the UV takes the GNSS measurements, the force measurements at both ends of the tether, the length of the tether in the water, the depth of the UV, and velocity measurement to calculate the geodetic (absolute) direction and velocity of the water current and the UV relative position to the SE to aid the UV INS.

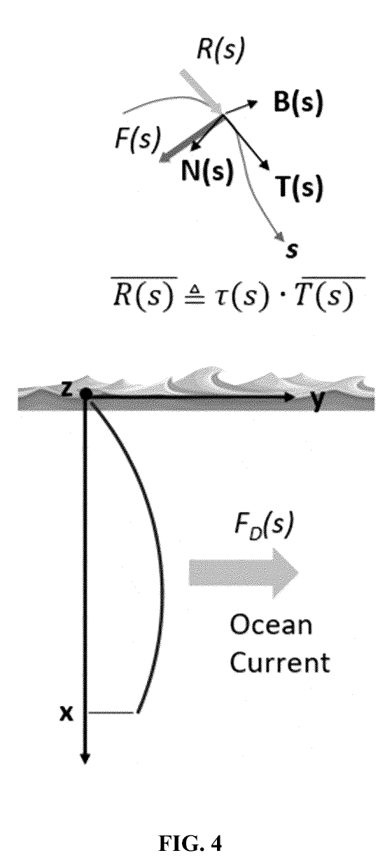

Referring to FIG. 4, assuming that the tether is perfectly flexible, thus, the tether's tension R(s) is always aligned with the local tangent—s is the curvilinear coordinate. Further assuming that the tether is in static equilibrium under the external forces F(s), thus, the local equilibrium equation for the tether is as follows:

$$\frac{d ( τ ( s ) \cdot T ( s ) )}{ds} + F ( s ) = 0 \qquad T ( s ) = \{ \begin{matrix}\frac{dx}{ds} & \frac{dy}{ds} & \frac{dz}{ds}\end{matrix} \}$$

The tether cannot exercise force along B(s) s), so, its osculating plane {x, y} is parallel to the ocean current and the drag force F(s) of the water. Projecting the equilibrium equation on the osculating frame x, y, the following relationships are obtained:

$$\{ \begin{matrix}\frac{d ( τ \frac{dx}{ds} )}{ds} + {F}_{Dx} ( s ) = 0 & ( a ) \\ \frac{d ( τ \frac{dy}{ds} )}{ds} + {F}_{Dv} ( s ) = 0 & ( b ) \\ \frac{d ( τ \frac{dz}{ds} )}{ds} = 0 & ( c )\end{matrix}$$

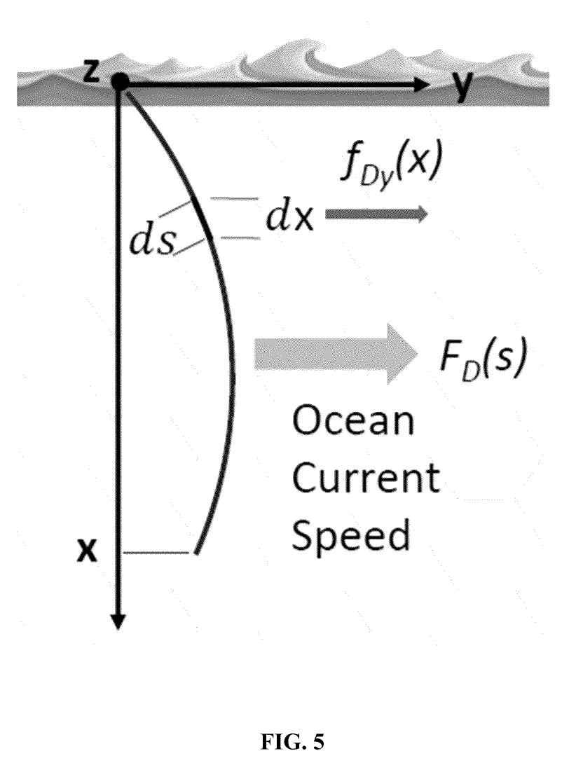

Referring to FIG. 5, assuming F_{Dx}(s)≅0, which with (a) yields the following:

$$T \frac{dx}{ds} = const \qquad ( d )$$

Noticing that with

$$\frac{dy}{ds} = \frac{dy}{dx} \frac{dx}{ds} = {y}^{′} ( x ) \frac{dx}{ds} ,$$

it can be deduced that

$$\frac{dy}{ds} = {v}^{′} ( x ) \frac{const}{τ} .$$

Substituting the latter in (b), the following expression is obtained:

$${y}^{″} ( x ) \frac{{const}^{2}}{\text{?}} + {F}_{Dy} ( s ) = 0 \qquad ( e )$$

$$\text{?} \text{indicates text missing or illegible when filed}$$

The following relationship is observed:

$${F}_{Dy} ( d ) ds ≅ {f}_{Dy} ( x ) dx .$$

Thus, the shape of tether under the force of the ocean current (when f_{Dy}=const) is a parabola—e.g.,

$${y}^{″} ( x ) = - \frac{{f}_{Dy} ( x )}{const} ,$$

whose solution is as follows:

$$y ( x ) = {ax}^{2} + bx + c .$$

f_{D}(x) is the specific drag force, which is proportional to the exposed cross-section of the tether, e.g., its thickness _{φt} times dx, and a power of the water relative velocity, which is assumed to be the second power.

Note that this analysis models the case of a stretch of tether exposed to one ocean current. The presence of plural currents can be modeled as a composition of arches, e.g., parabola.

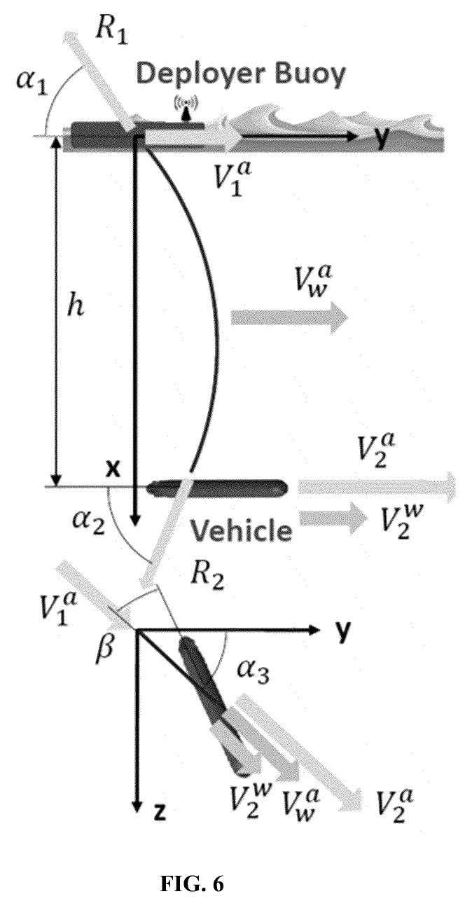

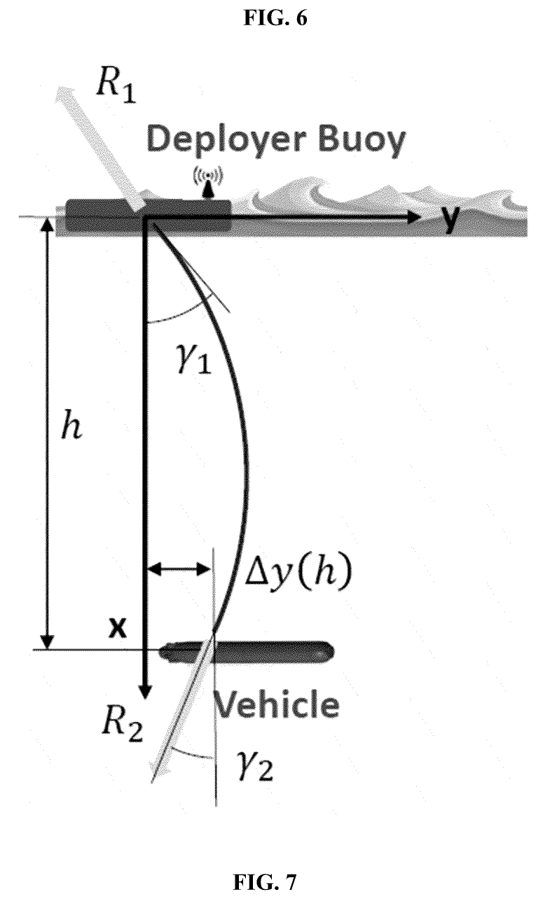

Referring to FIG. 6, the tether can deploy from either end, herewith without loss of generality. TODD can use the measurements of R1, R2 α1 α2 α3 from 3D load cells and angular sensors onboard the UV and the SE. TODD uses the measurements of V₁^{a} from the GNSS receiver, V₂^{w} from the relative velocity sensor, and h from the depth sensor. This is a simplified geometry model. In reality the tether plane is slanted because the SE and the UV do not necessarily align vertically. In this approximation of a use-case it can be assumed that the relative velocity of the water with respect to the tether varies linearly with depth−V_{w}^{r}=ax+c, and thus V_{w}(0)=V_{w}^{a}−V₁^{a} and V_{w}^{r}(h)=V₂^{w}. Thus, from V₂^{a}=V₂^{w}+V_{w}^{a}, the following expression is derived:

$${V}_{{w}^{r}} ( x ) = ( {V}_{{1}^{a}} + {V}_{{2}^{w}} - {V}_{{w}^{a}} ) x / h + {V}_{{w}^{a}} - {V}_{{1}^{a}} . \qquad ( f )$$

Imposing the static equilibrium of the tether, we can write the following eq.

$${R}_{1} cos {α}_{1} + {R}_{2} cos {α}_{2} - \frac{1}{2} {\int }_{0}^{h} {c}_{x} {φ}_{t} {{ρ}_{w} ( {V}_{w}^{r} ( x ) )}^{2} dx = 0. \qquad ( g )$$

φt is the thickness of the tether, ρw is the density of the water, and cx is a drag coefficient specific to the geometry of the tether. Substituting (f) in (g) and solving for V_{w}^{a} generates the following expression:

$${V}_{w}^{a} = {V}_{1}^{a} - \frac{1}{2} {V}_{2}^{w} + \sqrt{\frac{3 ( 8 {c}_{x} + h {φ}_{t} {{ρ}_{w} ( {V}_{2}^{w} )}^{2} - 8 cos {α}_{1} {R}_{1} - 8 cos {α}_{2} {R}_{2} )}{4 h {φ}_{t} {ρ}_{w}}} \qquad ( i )$$

Its sensitivity equation for an exemplary use-case is as follows:

$$\begin{matrix}∝ {10}^{- 1} & ∝ {10}^{- 1} & ∝ {10}^{- 2} & ∝ {10}^{- 2} & ∝ {10}^{- 2} & ∝ {10}^{- 2}\end{matrix} \qquad ( l )$$

$${dV}_{w}^{a} = {dV}_{1}^{a} + \frac{δ {V}_{w}^{a}}{δ {V}_{2}^{w}} {dV}_{2}^{w} + \frac{δ {V}_{w}^{a}}{δ R} dR + \frac{δ {V}_{w}^{a}}{δ h} dh + \frac{δ {V}_{w}^{a}}{{δα}_{1}} d {α}_{1} + \frac{δ {V}_{w}^{a}}{{δα}_{2}} d {α}_{2}$$

The predominant uncertainty contributions come from V₁^{a} and V₂^{w}. The INS of the UV also accounts for the other observables like β (without loss of generality). These formulas assume that V_{w}^{r} varies linearly with depth and that the water drag force is function of (V_{w}^{r})².

Referring to FIG. 7, under the assumption of uniform loading, it is demonstrated that the tether's shape is described by the following general equation (x)=ax²+bx+c. Imposing the following boundary conditions: (0)=0, y′(0)=tan γ₁, and y′(h)=tan γ₂, the following results are obtained: c=0, b=tan γ₁, and a=(tan γ₁-tan γ₂)/2h, which in turn, result in the following expression: y(h)−y(0)=Δy(h)=h/2 (tan γ₁+tan γ₂). Thus, by measuring the angles γ₁ and γ₂ of the forces at the tether's tips and the UV depth, the UV's position relative to the SE is observed. The sensitivity equation for (m) is as follows: Δ(h)=Δy(h)/h dh+h/2*(1/cos² γ₁+1/cos² γ₁) dγ. Other assumptions of drag loading can be made yielding different shape models, which are used to approximate/describe different mission and environmental conditions and parameters.

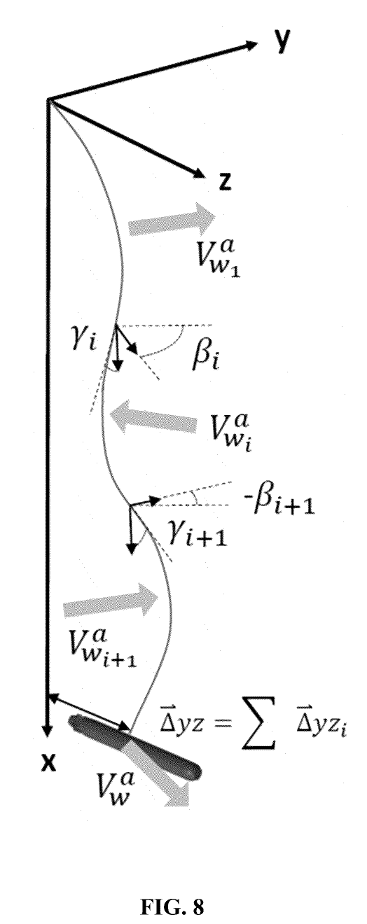

Referring to FIG. 8, the water column has many currents of different strengths and directions. As the UV descends the water column, the tether experiences inflection points where the direction of the current and its curvature change. The different sections of the tether align with the respective currents. Each section of the tether can be modelled with arches of parabola or higher order functions sharing common boundary conditions. The relative position of the UV with respect to the SE is observed through the summation of the individual tip to tip offsets calculated as in equation (m). The speed of the different currents is estimated recursively using equation (i) compounding the knowledge of the currents previously estimated. A pre-filter hosting the algorithm produces estimates (with uncertainties) of the relative position of the UV with respect to SE and the ocean current V_{w}^{a} currently affecting the UV. Such estimates are supplied to the UV INS as aiding for a blended solution.

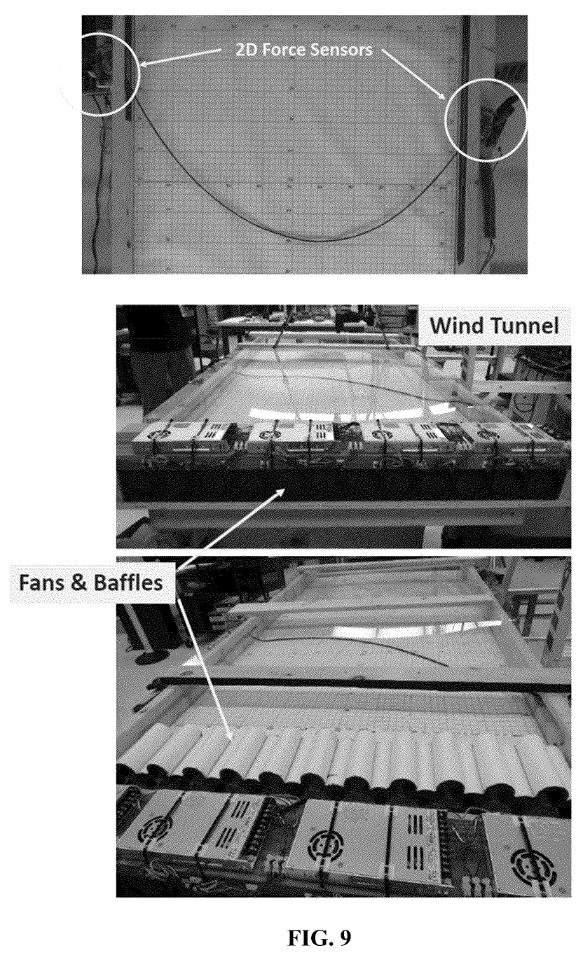

FIG. 9 shows an experimental set up in a wind tunnel to test an exemplary implementation of the fluid-current and position sensor. Operating parameters were as follows:
Wind tunnel with air velocity up to 11.2 m/s
Velocity accuracy ∓5%1σ
Velocity uniformity across field ∓5%1 σ
Two 2D force sensors composed of 4 SMD S256 30 load cells (max tension 30 g, accuracy ∓0.025 g1σ
A light wool yarn was used as tether. The tether shape was deduced by processing its image against a grid in the background accuracy ∓3 mm 1 σ.

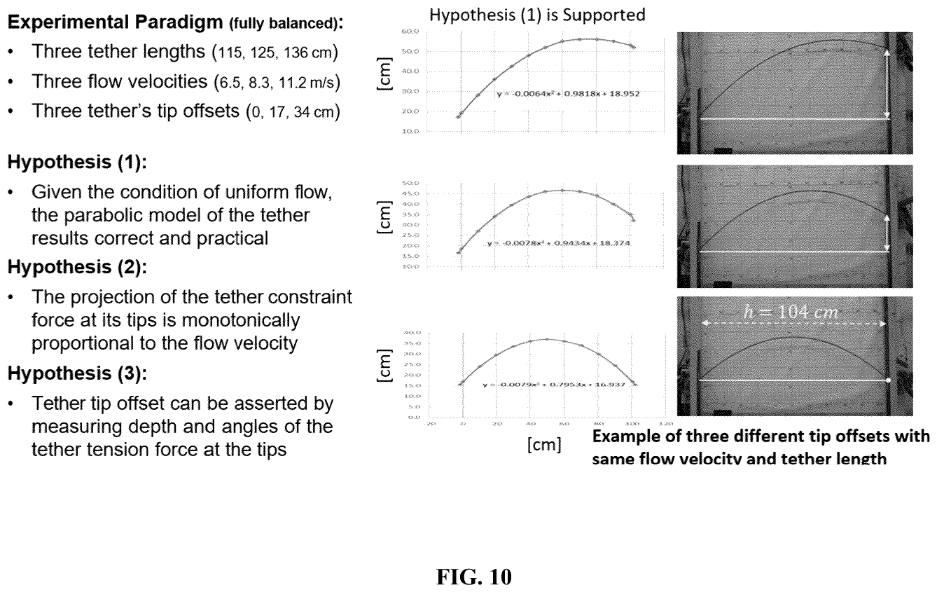

FIG. 10 shows results of the wind tunnel test.

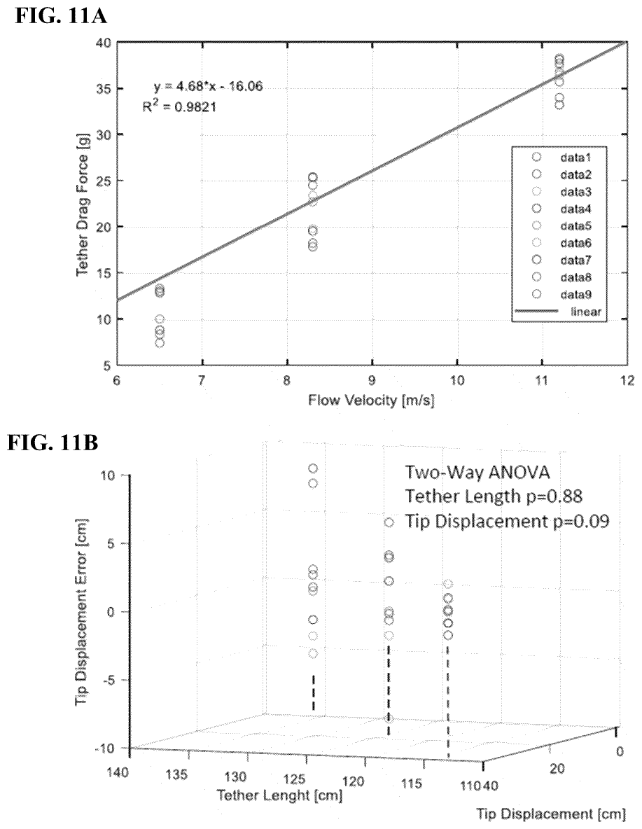

Referring to FIGS. 11A and 11B, results show an unambiguous monotonic relationship between flow velocity and the measured drag force on the tether, which supports the hypothesis of the sensor being a velocity sensor. These proof-of-concept data are a preamble to water testing that will yield the proper sensor-drag calibration curve, which would be most likely different for different types of tether. Results show that the tip-displacement can be observed as hypothesized, even with cursory angle measurements; the error was ˜3.4% 1σ of the depth, which is promissory of uncertainties of a few tens of meters at depths of thousands. Results show that the uncertainty on the estimate of the tip displacement is sensitive to the tether length, and it is larger the longer the tether and the smaller the tip displacement are. This small data sample seems to be in keeping with the sensitivity equation (n), where the 1/cos² (γ) factors amplify the estimate errors for large γ angles or saggy tethers.

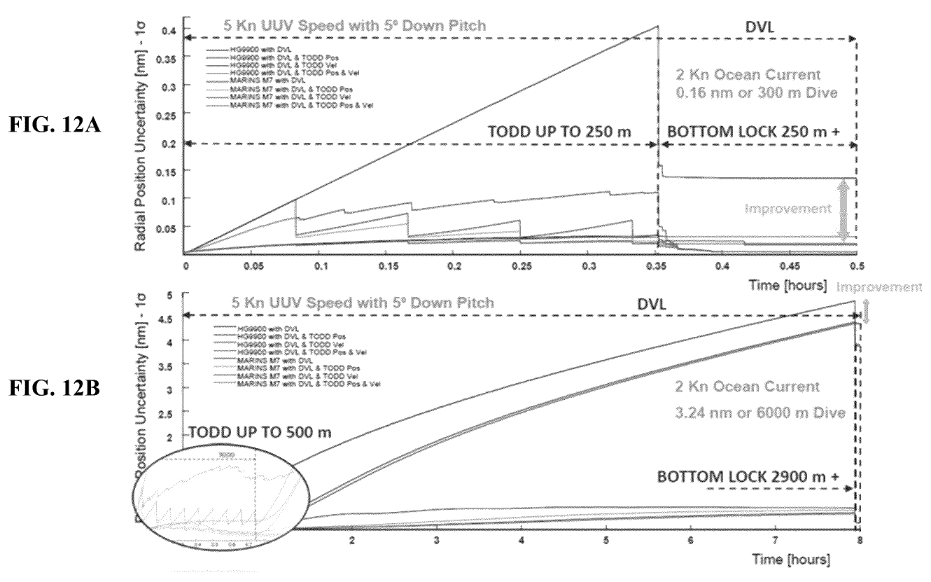

FIGS. 12A and 12B show covariance analyses with velocity and relative position measurements.

### Example 2

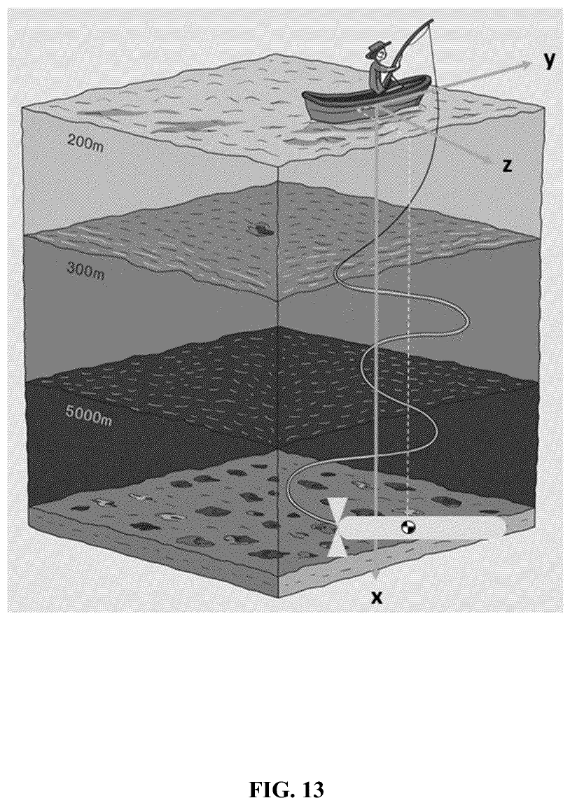

Referring to FIG. 13, there are typically three current layers in the ocean. The first layer is the top 100 to 200 meters. The currents in this layer are driven by surface winds. This layer also includes Ekman transport, which results from a balance between Coriolis and turbulent drag forces. The second layer is 100 to 500 meters. Currents in this layer are driven by horizontal pressure gradients, which are locally dependent. Within a region, the vertical gradients are roughly uniform, and therefore the forcing function gives roughly a uniform flow. The third layer is below 500 meters. This layer includes slow and large area currents driven by large scale features, gyres, and thermohaline circulation. For a particular region, these are likely to be roughly constant as well. How finely currents split into different layers depends on the density gradient, which drives the stability/strength of the stratification.

Generally, in an ocean water environment, the first 100 m to 500 m from the surface are challenging because of the complexity of ocean currents. Below 500 m the currents are “quieter,” but the hydrodynamic loads on the tether should be minimized. A low-tier marine-grade INS can provide good level information with respect to an absolute North-East-Down (NED) frame. However, embodiments of the tether disclosed herein can improve upon position sensing. Like a fishing line in the water, a thin tether aligns with the directions of the currents. Knowing the shape of the tether yields the offset of one of its ends with respect to the other. Thus, it produces the x-y-z position on the UV with respect to the surface or a SE. Also, the forces at tips of the tether are related to the velocities of the currents.

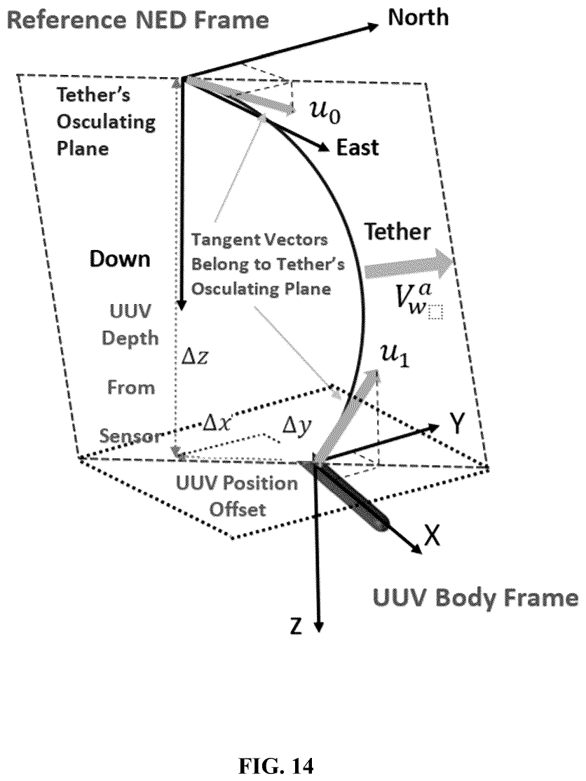

FIG. 14 is a depiction of one tether section subjected to one current with one direction. The tether cannot oppose lateral resistance, so it lays in an osculating plane parallel to the current. The osculating plane intersects the coordinate frames of connected platforms providing a common reference. The osculating plane is identified by the sensing the tether angles at the attachment points. A model of the tether shape together with the measured angles yields the offset between the two tips.

Table I shows different operational modes of embodiments of TODD, which may include use of other systems to augment TODD. FIGS. 15A and 15B show different mission capabilities for embodiments of TODD. As can be appreciated, embodiments of the tether can allow for: a) absolute positioning to self-locate or locate items on the seafloor (within a limited area); b) absolute self-positioning while traveling long distances; c) relative self-positioning with respect to a master vessel/platform; d) mapping or surveying large areas; d) stealth/undetectable operation and clandestine communications.

TABLE I
Different Operational Modes Of TODD

| | | Sub-sea Operation Without |
|---|---|---|
| Operating on the Surface | Assisted from the Surface | Assistance from the Surface |
| GPS | Acoustic, e.g., USBL | VLF (within <100 m form |
| | (within an area) with | the surface, long-distance |
| | GPS | travel) |
| RF trilateration, | SkyMark with TODD | Gravimeter with gravity- |
| e.g., eLoran (long- | (within depth <600 m, | anomaly mapping (long- |
| distance travel) | long-distance travel) | distance travel) |
| SkyMark (stellar with | TODD with GPS (deep- | Magnetometer with |
| resident space-bodies, | diving and long- | magnetic-anomaly mapping |
| long-distance travel) | distance travel) | (long-distance travel) |
| GroundMark (stellar | SmartTether with GPS | Sonar or depth sensor with |
| with landmarks, | (within a shallow area | bathymetric maps (long- |
| coastal) | and depth <100 m/200 m) | distance travel) |

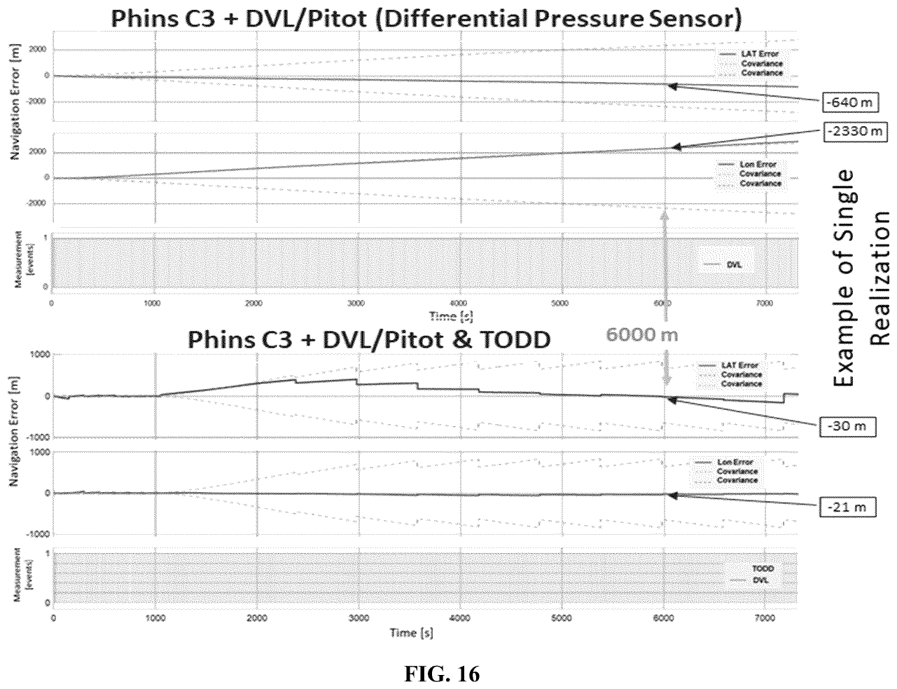

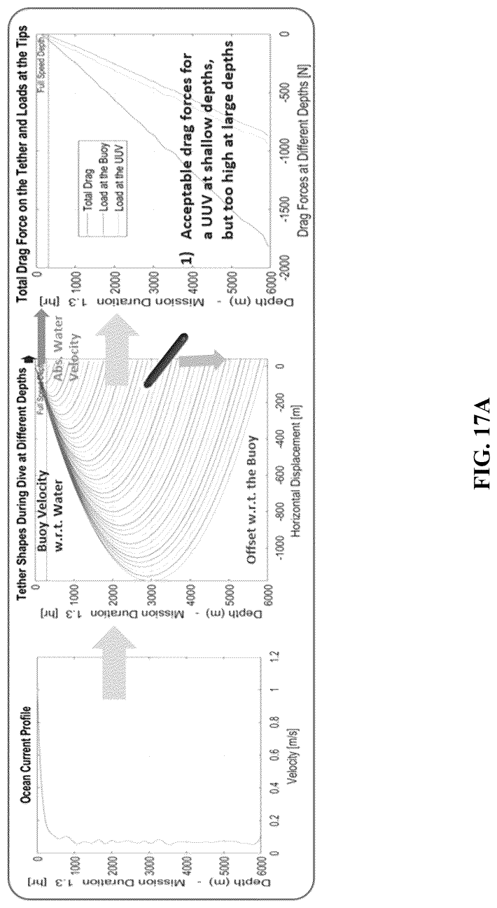

FIG. 16 shows preliminary simulation results. Simulation results reveal that TODD with curvature sensing can be used effectively down to a depth of 900 m, TODD with a tether-shape model can be used effectively between 2000 m and 6000 m, TODD with curvature sensing yields position errors on the order of meters down to 900 m, and at the seafloor TODD reduces the position error dramatically. TODD can also operate at all different depths and ranges of depths or horizontal distances if operated horizontally/off-vertical.

With conventional fiber-optic tethers and umbilical cables, a deployer ship lowers a “depressor” by tens of meters to cope with (strong) surface currents and potential entanglements with marine life. At a quieter depth, up to 20 Km of tether is let freely unspooling from canister(s) on the depressor and/or on the UV. The tether is pulled out by the water drag and slowly sinks. Operation depths with such a system can be up to 11,000 m. Umbilical cables are typically used with remote operated vehicles (ROVs) for power, communications, and lowering/hoisting capabilities. ROV are very heavy and powerful, wherein heave control is used on the ship to control cable tension, loads on the umbilical cable are on the order of 10⁴/10⁵ N, and common seafloor-operation is at approximately 6000 m.

With fiber-optic versions of the disclosed tether, it is contemplated to use a titanium-doped silica-core fiber, which is more survivable that other fibers and pays out successfully from hollow spools. An armored fiber can also be used, but this required the tether to have a larger diameter. Embodiments can use effectively within the first 500/1000 m curvature/shape sensing, short-range acoustic to a depressor, or a combination of the two to deal with the challenge of the surface currents. Embodiments can be used effectively beyond 100/1000 m to the seafloor with use of mathematical models of the tether. When adding force sensing at the SE (or depressor) and at the UV, the system can also assess the absolute velocity of the water, i.e. the strength of the current.

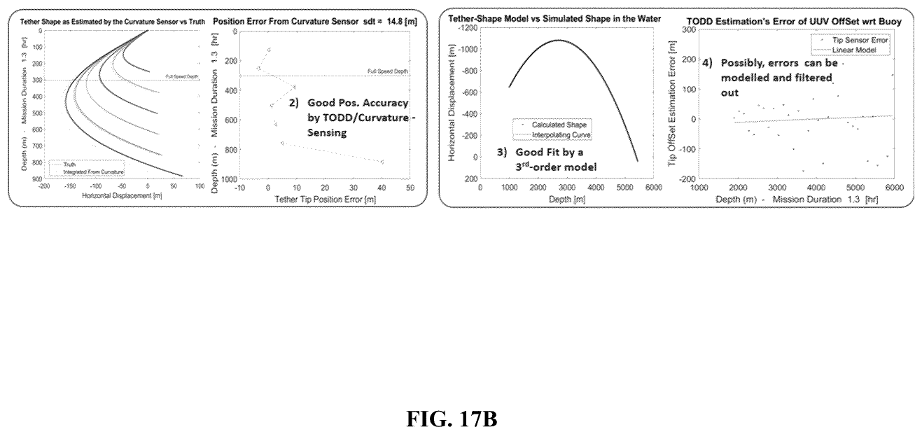

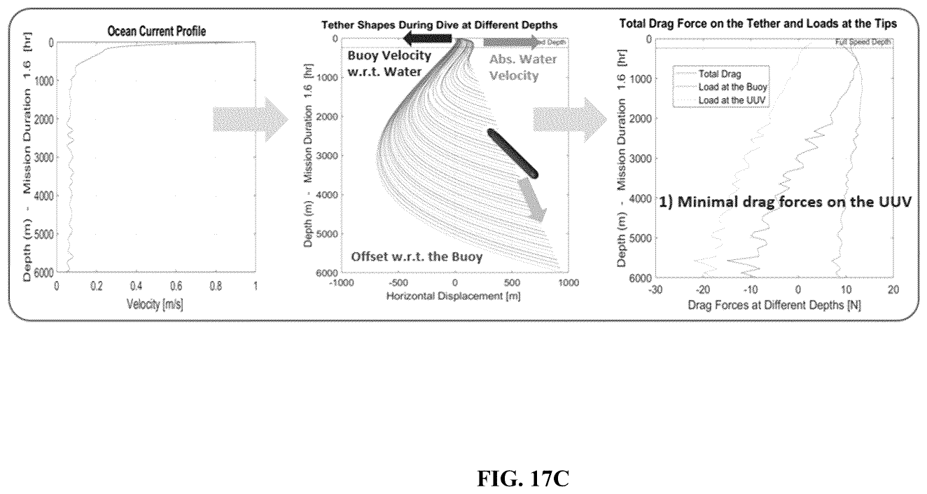

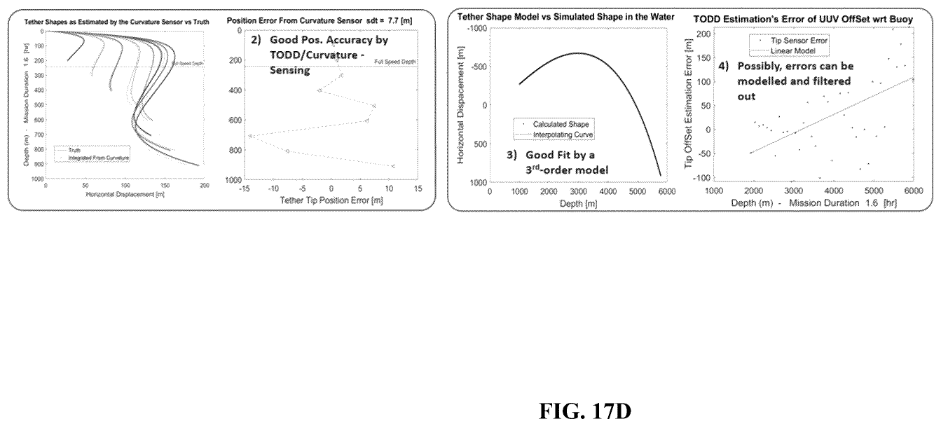

Referring to FIG. 17A, the UV dives with a constant nose down pitch of 55° and propeller speed of 3 kn; the SE follows the current on the surface; curvature sensing operates down to 900 m; and the tether-shape model is used from 2,000 m to 6,000 m. This generates large drag forces, which may not be an issue for some UVs, but not in general.

Referring to FIG. 17C, coordinated SE-UV motion can balance drag forces on the tether and relieves loads on UV at large depths. Under such scenario: the UV dives with constant a nose down pitch of 80° and propeller speed of 2 kn, the SE rides against the current, curvature sensing operates down to 900 m, and the tether-shape model is used from 2,000 m to 6,000 m.

Referring to FIGS. 17B and 17D we see the positioning performance and accuracy under the mission parameters relative to FIGS. 17A and 17C.

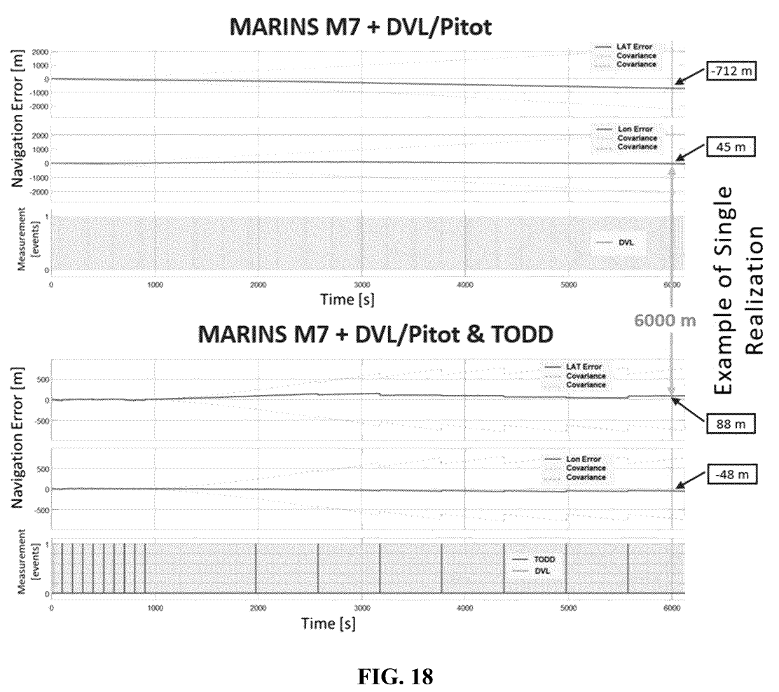

FIG. 18 shows preliminary simulation results with an iXblue MARINS M7. This simulation involved a time-based simulation with strapdown mechanization, EKF, and DVL/Pitot active at all times. One current and direction was used with profile shown in FIG. 17A. TODD with curvature sensing was used down to a depth of 900 m. TODD with a tether-shape model was used between 2000 m and 6000 m. The INS alone yielded large position errors at the seafloor (6000 m), when subjected to realistic water currents. TODD with curvature sensing yielded position errors on the order of meters down to a depth of 900 m. At the seafloor TODD reduced the position error by 7 times (in this example).

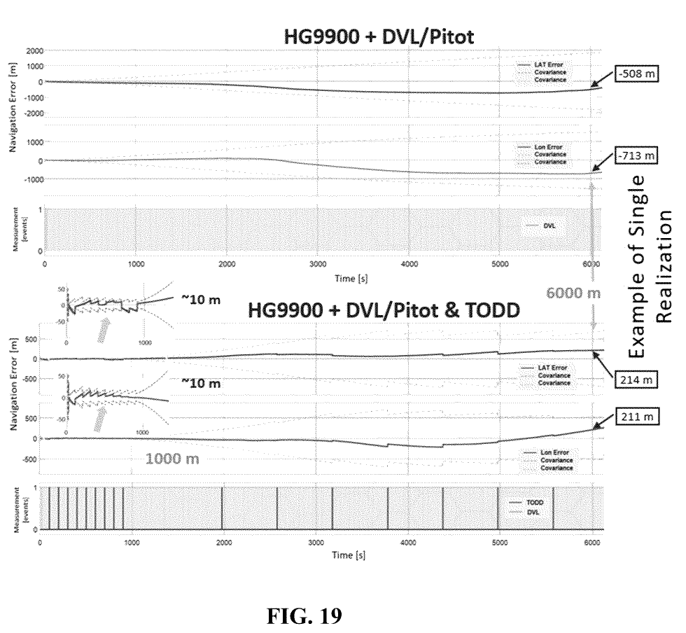

FIG. 19 shows preliminary simulation results with a Honeywell HG9900. This simulation involved a time-based simulation with strapdown mechanization, EKF, and DVL/Pitot active at all times. One current and direction was used with profile shown in FIG. 17A. TODD with curvature sensing was used down to a depth of 900 m. TODD with a tether-shape model was used between 2000 m and 6000 m. A commercial aircraft navigation-grade IMU alone yielded errors at seafloor (6000 m) of little less than 1 km when subjected to realistic water currents. TODD with curvature sensing yielded position errors on the order of meters down to a depth of 900 m. At the seafloor TODD reduced the position error by 3 times (in this example).

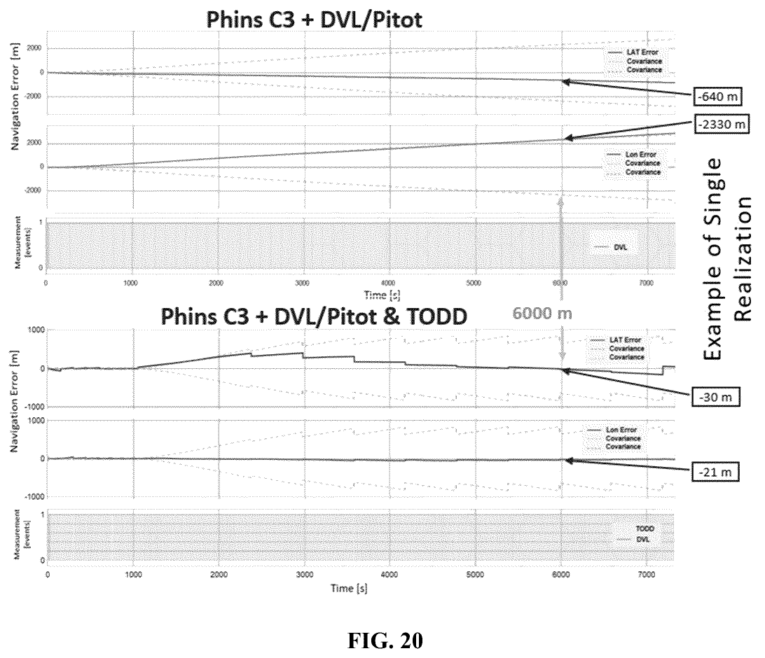

FIG. 20 shows preliminary simulation results with a Phins C3. This simulation involved a time-based simulation with strapdown mechanization, EKF, and DVL/Pitot active at all times. One current and direction was used with profile shown in FIG. 17A. TODD with curvature sensing was used down to a depth of 900 m. TODD with a tether-shape model was used between 2000 m and 6000 m. A commercial tactical-grade IMU alone yielded errors at seafloor (6000 m) in the order of kilometer. TODD with curvature sensing yielded position errors on the order of meters down to a depth of 900 m. At the seafloor TODD reduced the position error dramatically (in this example).

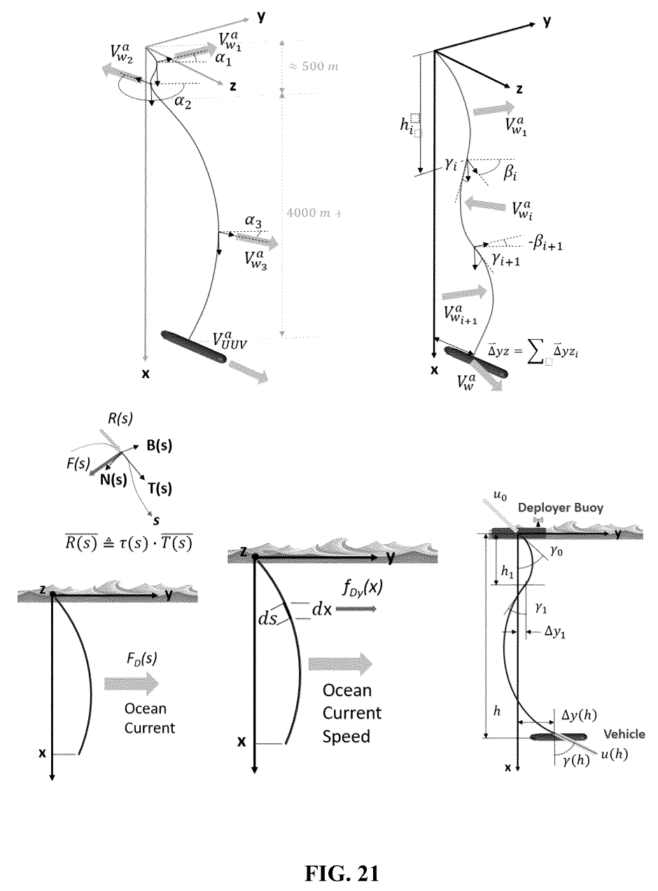

With reference to FIG. 21, EXAMPLE 2 demonstrates how a cubic model can be used. FIG. 21 shows how embodiments of the disclosed system can address presence of ocean currents of different directions at depth using a composition of the tether's sections in different planes that share common boundary conditions. The illustrations demonstrate modeling an embodiment of the tether when diving in a water column with different current layers, each with a potentially different direction. As the UV descends the water column, the tether experiences inflection points where the direction of the current changes. The UV INS detects those inflections points by sensing the change of the relative velocity of the water current and of the tether plane with respect to the UV. The tether is depicted/modelled with separate arcs sharing common boundary conditions specifically with reference to the more common case where the water column is dominated by three major currents. The relative position of the UV with respect to the SE is observed through the summation of the individual tip-to-tip offsets. In less general conditions, the addition of force sensing at the attachment points of the tether allows for the observation of water-current velocities.

The following discussion explains how TODD leverages a cubic model of a flexible continuum subjected to a distributed load. Similar to the parabolic model (discussed in EXAMPLE 1), we assume that the tether is perfectly flexible, and thus the tether's tension R(s) is always aligned with the local tangent—s is the curvilinear coordinate. We assume that the tether is in static equilibrium under the external forces F(s), thus, the local equilibrium equation for the tether is as follows:

$$\frac{d ( τ ( s ) \cdot T ( s ) )}{ds} + F ( s ) = 0 \qquad T ( s ) = \{ \begin{matrix}\frac{dx}{ds} & \frac{dy}{ds} & \frac{dz}{ds} \}\end{matrix}$$

Projecting the equilibrium equation on the osculating frame {x, y, z}, we obtain the following relationships:

$$\{ \begin{matrix}\frac{d ( τ \frac{dx}{ds} )}{ds} + {F}_{Dx} ( s ) = 0 \\ \frac{d ( τ \frac{dy}{ds} )}{ds} + {F}_{Dy} ( s ) = 0 \\ \frac{d ( τ \frac{dz}{ds} )}{ds} = 0\end{matrix}$$

The tether cannot exercise force along B(s), so, its osculating plane {x, y} is parallel to the ocean current and the drag force F_{D}(s) of the water. See FIG. 21. We assume F_{Dx}(s)≅0, which with (a) yields the following

$$τ \frac{dx}{ds} = const .$$

Noticing that

$$\frac{dy}{ds} = \frac{dy}{dx} \frac{dx}{ds} = {y}^{′} ( x ) \frac{dx}{ds} ,$$

we deduce that

$$\frac{dy}{ds} = {y}^{′} ( x ) \frac{const}{τ} .$$

Substituting the latter in (b), we obtain the following expression

$${y}^{″} ( x ) \frac{{const}^{2}}{τ} + {F}_{Dy} ( s ) = 0.$$

We also observe the following relationship: F_{Dy}(s)ds≅f_{Dy}(x)dx. Thus, the shape of the tether under the forces of the ocean current can be calculated as follows:

$${y}^{″} ( x ) = - \frac{{f}_{Dy} ( x )}{const} \cdot {f}_{Dy} ( x )$$

is the specific drag force, which is proportional to the exposed cross-section of the tether, i.e., its thickness φₜ times dx, and a power of the water relative velocity, which at this time, we assume to be the second power.

The presence of ocean currents of different directions with depth, can be addressed with a composition of tether's sections in different planes that share common boundary conditions.

TODD can sense the UV's position relative to the SE. Integration of the sensed curvature using (m), provides the tether-tip position Δy(h(x)) and orientation γ(h(x)) on the plane identified by the tether with respect to the SE and the UV body frames up to a depth h₁:

$$Crv ( x ) = \frac{{y}^{″} ( x )}{\sqrt[3 / 2]{1 + {( {y}^{′} ( x ) )}^{2}}}$$

At h₁, which is chosen past the bulk of the surface currents, the tether tip orientation and offset with respect to the SE are γ₁ and Δy₁, respectively. Preliminary numerical simulations indicate that at depths past the surface currents the tether's shape can be reasonably-well described by the following general equation y(x)=ax³+bx²+cx+d. Imposing the boundary conditions, γ₁ and Δy₁ at h₁, accounting for the length of the tether, and the tether orientation γ(h) measured at the UV, with the use of (n) we calculate the UV offset with respect to the SE. Parabolic arches can also be used as indicated in paragraph 112.

In some embodiment, TODD uses a fiber-optic tether attached to a SE to yield the UV position during the dive. With such embodiments, the TODD system does not need to transmit detectable energy in the water (i.e., it can operate with stealth capabilities), it allows undetectable high-bandwidth communications between the surface and the UV (i.e., it can operate with covert capabilities), and the UV does not need to spiral during the dive in order to allow communications with the surface.

With conventional UV navigation systems, the UV INS self-aligns on the surface with GPS or transfer-aligns using the ship's INS. For unaided dives, the UV relies on an INS, a water-track sensor for relative velocity, and a pressure-sensor for depth. Once 100 m-500 m from the bottom, the UV is usually equipped with an acoustic sensor (DVL, Doppler Velocity Log, etc.) to obtain ground-referenced velocity. This conventional approach presents the following issues: a) the UV INS goes inertial/unaided for 1 hr./2+ hrs. during the dive, which requires very expensive and heavy INS when position accuracy is needed within tens of meters; b) once in sight of the bottom, the DVL only bounds the velocity error and the position error grows to within 0.1%-1% of the traveled distance.

TODD can sense the direction of ocean currents and the offset of its tips using a fiber-optic tether. As a fishing line in the water, the tether orients with the current assuming the geodetic heading of the ocean current. The plane containing the tether also constitutes a common reference between the SE and the UV allowing for observability of the relative heading between the two. Both the SE and the UV have sensors to measure the tether orientation with respect to their respective body frames and good-enough INS to hold good tilt and heading with respect to an absolute geodetic frame. The shape of the tether assumed in the water is either measured or modelled in order to observe the offset of its tips with respect to each other. Thus, from the tip position on the SE that has the GNSS receiver, it is inferred the UV's absolute position at the end of the tether. The SE with the GNSS receiver measures the length of the tether deployed over time and controls the tension of the tether during the dive. The UV measures its depth (depth sensor) and its relative velocity with respect to the water column using a high-end Pitot tube or a high-frequency DVL with limited propagation through the water.

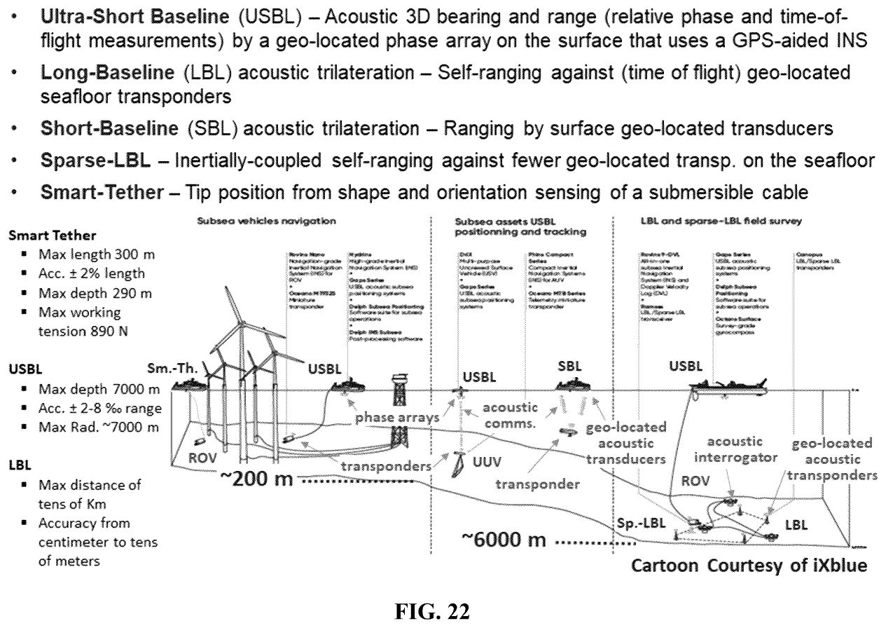

Referring to FIG. 22, if loud and heavy operations are not of concern, acoustics can be used. Some acoustic systems can include:
Ultra-Short Baseline (USBL)—Acoustic 3D bearing and range (relative phase and time-of-flight measurements) by a geo-located phase array on the surface that uses a GPS-aided INS.
   Max depth 7000 m.
   Acc. ±2-8‰ range.
   Max Rad. ˜7000 m.
Long-Baseline (LBL) acoustic trilateration—Self-ranging against (time of flight) geo-located seafloor transponders.
Short-Baseline (SBL) acoustic trilateration—Ranging by surface geo-located transducers.
Sparse-LBL—Inertially-coupled self-ranging against fewer geo-located transponders on the seafloor.
   Max distance of tens of Km.
   Accuracy from centimeter to tens of meters.
Smart-Tether-Tip position from shape and orientation sensing of a submersible cable.
   Max length 300 m.
   Acc. ±2% length.
   Max depth 290 m.
   Max working tension 890 N.

Ultra-Short Baseline (USBL) Positioning System is a convention system which TODD improves upon. Characteristics of a USBL positioning system can include:
It is very accurate and used for precision tracking and/or positioning of subsea vehicles and assets.
Requires complex hardware on the supporting vessel not limited to a depressor post to mount the multi-element acoustic array/transducer.
It requires a GPS-aided INS to track the location and orientation of the acoustic array attached to the ship.
Every ping yields range to a feature via Two-Way Travel Time (TWTT) and its bearing with respect to the array.
Feature detection in the array's 3D-frame, together with the array position and orientation in a geo-located frame, yields the positions of subsea features in absolute coordinates.
Fixes can be passed to the UV using acoustic communications.
Pings are occasionally subjected to multi-paths giving erroneous fixes.
Multipath (fault) can be detected by the UV's INS, for an example comparing depth from ranging with the UV's pressure readings.
Accuracies are in the order of tens of centimeters to tens of meters depending upon the range of the detected features.

A Long-Baseline (LBL) and Sparse-LBL Positioning System is a convention system which TODD improves upon. Characteristics of a LBL positioning system can include:
LBL is the oldest and most common subsea positioning technique.
Depth is derived from pressure sensing onboard the vehicle while its 2D location is produced by TWTT from three or more geo-located transponders.
Deployment and calibration of the transponders on the seafloor require substantial effort.
Accuracies ranging from tens of centimeters to tens of meters depending upon the range.
With less than three transponders, relative ranging to a known location can still be used to aid the onboard INS.
Ranging to three or more geo-located transponders yields a 2D position fix, while depth is from pressure sensing.

Smart Tether is a conventional system which TODD improves upon. Technology of the Smart Tether can be appreciated from U.S. 2008/0300821. Characteristics of a Smart Tether positioning system also include:
Smart Tether in is a positioning sensor in a form of a flexible cable that senses the position of one of its tip.
To perform this function, it embeds a variety of sensors other than force sensors. Contrarily, TODD does not embed any sensors within the tether, but uses measurements by the deployer on the SE and the UV to aid the UV's INS.
It exploits the Catenary equation to model the cable's shape in the water.
Its general use is to track underwater vehicles or divers for hull or mine inspection. Similar techniques are also used in towed arrays.
The Smart Tether's software makes assumptions about the shape of the tether.
Smart Tether does not perform well with slack.
Suggested use is with minimum lengths.
No reference is made to the drag generated by water currents given the Smart Tether sizable cross section, which might make operation unpractical in presence of large lengths and strong currents.

It should be understood that the disclosure of a range of values is a disclosure of every numerical value within that range, including the end points. It should also be appreciated that some components, features, and/or configurations may be described in connection with only one particular embodiment, but these same components, features, and/or configurations can be applied or used with many other embodiments and should be considered applicable to the other embodiments, unless stated otherwise or unless such a component, feature, and/or configuration is technically impossible to use with the other embodiment. Thus, the components, features, and/or configurations of the various embodiments can be combined together in any manner and such combinations are expressly contemplated and disclosed by this statement.

It will be apparent to those skilled in the art that numerous modifications and variations of the described examples and embodiments are possible considering the above teachings of the disclosure. The disclosed examples and embodiments are presented for purposes of illustration only. Other alternate embodiments may include some or all of the features disclosed herein. Therefore, it is the intent to cover all such modifications and alternate embodiments as may come within the true scope of this invention, which is to be given the full breadth thereof.

It should be understood that modifications to the embodiments disclosed herein can be made to meet a particular set of design criteria. Therefore, while certain exemplary embodiments of the systems and methods using and making the same disclosed herein have been discussed and illustrated, it is to be distinctly understood that the invention is not limited thereto but may be otherwise variously embodied and practiced within the scope of the following claims.

What is claimed is:

1. A fluid current measurement and/or position sensing instrument, comprising:
an elongate structure capable of flexible movement and deflection due to fluid flow within a fluid column the elongate structure is immersed, the elongate structure having a first end and a second end;
a sensor system comprising:
plural organic sensor instruments (OSIs) configured to:
sense drag force, tension, deformation, deflection, and/or rotation experienced by the elongate structure at the first end, the second end, and an intermediate point between the first end and the second end; and
generate sensor signals representative of drag force vectors tension force vectors, deformation, deflection, and/or rotation; and
a communication medium in communication with the plural OSIs and configured to transmit the sensor signals to the first end and the second end; and
a processing module comprising a processor and a memory, the processing module configured to receive the sensor signals and determine: flow rate, flow direction, and fluid flux density of one or more fluid flow currents of the fluid column; and position of the second end relative to the first end.

2. The instrument of claim 1, wherein:
the elongate structure is a tether configured to connect to a SE at its first end and to an underwater vehicle (UV) at its second end;
the processing module is located at the SE or at the UV;
the processing module is configured to determine a position of the UV relative to the SE based at least in part on the flow rate, the flow direction, and the fluid flux density of the one or more fluid flow currents of the fluid column.

3. The instrument of claim 1, wherein:
the sensor system includes one or more load sensor, pressure sensor, force sensor, motion sensor, rotation sensor, flow sensor, Bragg grating, and/or Rayleigh scattering sensor.

4. The instrument of claim 1, wherein:
the communication medium is a flexible electrical conductor or a flexible optical waveguide.

5. The instrument of claim 4, wherein:
the flexible electrical conductor is an electrical conducting metal, metal alloy, or polymer; and
the flexible optical waveguide is an optical fiber.

6. The instrument of claim 1, wherein:
the elongate structure is covered with a coating.

7. The instrument of claim 6, wherein:
the coating includes protective material that is a high-strength cladding material or a high-strength braided material; and/or
the coating is a buoyant material.

8. The instrument of claim 2, wherein:
the SE includes a 3D load cell, an Internal Navigation System (INS), and a Global Navigation Satellite System (GNSS), other global positioning systems, angular sensors, tether-length sensors, each of which provide data to the processing module; and
the UV includes a 3D load cell, a depth sensor, a Doppler velocity sensor, and an INS, angular sensors, tether-length sensors, each of which provide data to the processing module.

9. The instrument of claim 2, wherein:
the SE includes a deployer that controllably releases or retracts the elongate structure and can determine a length of the elongate structure as measured from the deployer to the second end.

10. The instrument of claim 1, wherein:
the plural OSIs is configured to sense drag force, tension, deformation, deflection, and/or rotation experienced by the elongate structure at plural intermediate points between the first end and the second end.

11. The instrument of claim 10, wherein:
the processing module is configured to compute a profile of the elongate structure, the profile comprising plural overall shapes of the elongate structure at plural times, t, over a period of time, T.

12. The instrument of claim 11, wherein:
the processing module is configured to model one or more fluid flow currents based on inflection points in the profile.

13. The instrument of claim 12, wherein:
modelling one or more fluid flow currents involves estimating fluid flow current speed based on recursive analysis.

14. The instrument of claim 2, wherein:
the sensor system is configured to sense drag force, tension, deformation, deflection, and/or rotation experienced by the elongate structure at plural intermediate points between the first end and the second end;
the processing module is configured to:
compute a profile of the elongate structure, the profile comprising plural overall shapes of the elongate structure at plural times, t, over a period of time, T;
model one or more fluid flow currents based on inflection points in the profile;
update and/or predict the position of the UV relative to the SE.

15. The instrument of claim 14, wherein:
modelling one or more fluid flow currents involves estimating fluid flow current speed based on recursive analysis.

16. A fluid current measurement and/or position sensing instrument, comprising:
an elongate structure capable of flexible movement and deflection due to fluid flow within a fluid column the elongate structure is immersed, the elongate structure having a first end connectable to a SE and a second end connectable to an underwater vehicle (UV);
a sensor system comprising:
plural organic sensor instruments (OSIs) configured to:
sense drag force, tension, deformation, deflections, and/or rotation experienced by the elongate structure at the first end and the second end;
sense an angle between a longitudinal axis of the elongate structure at its first end and a reference frame of the SE;
sense an angle between a longitudinal axis of the elongate structure at its second end and a reference frame of the UV; and
generate sensor signals representative of drag force vectors, tension force vectors, deformation, deflection, rotation, and/or angles; and
a communication medium in communication with the plural OSIs and configured to transmit the sensor signals to the first end and the second end; and
a processing module comprising a processor and a memory, the processing module configured to receive the sensor signals and:
determine flow rate, flow direction, and fluid flux density of one or more fluid flow currents of the fluid column;
determine a position of the second end relative to the first end using a mathematical model of an overall shape of the elongate structure; and/or
determine a position of the second end relative to the first end using shape data from a curvature sensor of the elongate structure.

17. The instrument of claim 16, wherein:
the processing module is configured to infer a relative position of the UV with respect to the SE.

18. The instrument of claim 16, wherein:
the curvature sensor includes an optical fiber with Bragg grating or a Rayleigh scattering sensor.

19. The instrument of claim 16, wherein:
the processing module is configured to determine inflection points in the overall shape of the elongate structure using flow rate and direction data, the mathematical model, and/or shape data from the curvature sensor.
